(19) United States
(12) Patent Application Publication
(10) Pub. No.: US 2018/0023538 A1
(43) Pub. Date: Jan. 25, 2018

(54) SYSTEM AND METHOD FOR ARTIFICIAL GRAVITY FUELED FLUID DYNAMIC ENERGY GENERATOR OR MOTOR

(71) Applicant: Robert S. PRILL, Allenwood, NJ (US)

(72) Inventor: Robert S. PRILL, Allenwood, NJ (US)

(21) Appl. No.: 15/701,420

(22) Filed: Sep. 11, 2017

Related U.S. Application Data
(63) Continuation-in-part of application No. 14/412,682, filed on Jan. 4, 2015, now abandoned.
(60) Provisional application No. 61/799,828, filed on Mar. 15, 2013.

(51) Int. Cl. F03B 17/06; F03B 3/08

(52) U.S. Cl. CPC F03B 17/061; F03B 3/08; F05B 2260/71

(57) ABSTRACT

An generator/motor that initially uses external power to spin a partially submerged low drag fluid distributor rotor that uses centrifugal force to cause fluid to flow from the center of rotation, through a plurality of Euler curved penstocks, allowing the fluid to flow in a true radial direction through a high “g” artificial gravity field, which dramatically increases the fluid's kinetic energy and released available power (Pa), before it is guided out tangentially from the distributor via a plurality of nozzles symmetrically located at a small height just above the reservoir surface (near zero lift). As the frequency of the rotor is increased linearly the fuel artificial gravity increases exponentially, as does the fluid dynamic available power (Pa). Turbine runners on the rotor assembly capture the available power (Pa), and a positive feedback mechanical transmission couples the captured rotational power to the I/O shaft in its initialized direction thus replacing the external power with internal fluid dynamic derived mechanical power to sustain rotator rotation and drive the shaft of an electric generator.

### CROSS REFERENCE TO RELATED APPLICATION

This application is a continuation-in-part application of co-pending U.S. application Ser. No. 14/412,682 which was filed on Jan. 4, 2015, which is a 371 application of PCT/US14/30543 which was filed on Mar. 17, 2014 which, in turn, claims benefit of U.S. provisional application No. 61/799,828 which was filed on Mar. 15, 2013.

### TECHNICAL FIELD OF THE INVENTION

The present invention relates generally to energy generation, hydro-mechanical power generation, and distributed green reusable energy.

### BACKGROUND OF THE INVENTION

The global economy relies on a continuous, supply of coal, oil, and natural gas, and the refinement processes, necessary to produce power for virtually every power assisted device in the modern world. With the expanding growth in industrialization in new regions of the world, (China, OPEC nations, etc.) these high energy combustible fossil fuels are increasingly in demand at alarming rates causing supply and demand record high prices in highly volatile markets.

The current trend in many nations is to reduce their dependency on fossil fuels with alternative energy technologies i.e., corn-base ethanol, hydrogen based fuels, etc. and to revive the old reusable, pollution free water, wind, and solar natural energy base technologies. Each of these technologies have significant drawbacks. The alternative energy technologies (again, i.e., corn-based ethanol, hydrogen based fuels, etc.) are synthesized fuels that don't occur in nature and as such they require significant amounts of input energy to refine and similar amounts of energy (unaccounted for by the technology) to distribute them to the end user. The reusable technologies have a different set of drawbacks. Solar, whether it is used as a centralized or distributed energy source is terribly inefficient, and it is only available during daylight hours. Wind technologies are available day and night but only sporadically and it is mainly a centralized technology, requiring vast chunks of valuable real-estate for their wind turbines and having high energy transport charges to get the energy to the user. Water-based power generation is the most efficient but is a centralized technology with limited set geographic locations and suffers from the high energy transport charges to get power to the end user.

In light of the above, it is believed that the primary source of the world's energy needs will continue to come from the combustible fossil fuels of coal, oil and natural gas, (and from nuclear energy) well into the foreseeable future. It is also believed that the remedial, hot button alternative energy technologies of the day (ethanol, hydrogen based fuels, fuel cells, etc.), and the attempts of reviving the reusable technologies of wind and solar, as we know them now in their natural state with their inherent problems of unavailability (no wind or no sun) will not greatly reduce our energy dependency on fossil fuels.

### BRIEF SUMMARY OF THE INVENTION

The present invention includes an artificial gravity fueled fluid dynamic energy generator/motor comprising: a system control and brake assembly; a main bearing vertical shaft assembly connected to the system control and brake assembly; a stationary platform connected to the main bearing vertical shaft assembly; a ratchet assembly connected to the main bearing vertical shaft assembly; a rotor connected to the main bearing vertical shaft assembly wherein the rotor supports a fluid distributor; a turbine shaft connected to the rotor by at least one bearing support; a turbine runner connected to the turbine shaft by a gear box; a drive gear connected to the turbine shaft; a sun gear dynamically interfaced with the drive gear, and a hub extension connected to the sun gear; wherein the fluid distributor includes at least one penstock including an associated nozzle configured to propel a fluid from a reservoir to the turbine runner.

Another embodiment of the invention includes a method of generating artificial gravity fueled fluid power, capturing it, and self-sustaining the artificial gravity fueled power generation process, the method comprising the steps of: rotating a vertical shaft of main bearing vertical shaft assembly, an attached rotor, a fluid distributor attached to the rotor, and at least one penstock and its associated nozzle using an external cranking power in a first direction; forcing a fluid through the at least one penstock into a high artificial gravity domain where its kinetic energy is increased before it exits its associated nozzle such that the fluid impacts a turbine; rotating the turbine such that the rotation causes a rotation in a turbine shaft; rotating at least one drive gear from the rotation of the turbine shaft; causing the sun gear to spin in a first direction; slowing the sun gear down; attempting to spin the sun gear in a direction opposite to the first direction; detecting the fluid dynamic power is greater than the external cranking power; preventing the sun gear from rotating; causing the drive gear to rotate in the first direction around the now stationary sun gear; causing the drive gear to drag the rotor via its turbine shaft connection to bearing support connection to the rotor.

### BRIEF DESCRIPTION OF THE DRAWINGS

The drawings are meant to illustrate the principles of the invention and do not limit the scope of the invention. The above-mentioned features and objects of the present disclosure will become more apparent with reference to the following description taken in conjunction with the accompanying drawings wherein like reference numerals denote like elements in which:

FIG. 1 illustrates the earth's hydrodynamic eco-system highlighting how hydro-power generation is done today including the earth's reservoir replenishment process;

FIGS. 2A and 2B illustrate a method to transform earth's hydrodynamic eco-system processes to artificial gravity fueled synthetic eco-system processes;

FIGS. 3A and 3B illustrate a process to transform artificial gravity fueled synthetic eco-system processes to physics supported realization;

FIG. 4 illustrates a summary of transformation processes;

FIG. 5 illustrates the initial embodiment (vertical turbine) of artificial gravity fueled fluid dynamic energy generator/motor controlled by a closed loop braking system entity;

FIG. 6 illustrates the top view of a three-channel vertical turbine rotor assembly, including positive feedback transmission;

FIG. 7 illustrates an embodiment (horizontal turbine) of artificial gravity fueled fluid dynamic motor driving an electric generator;

FIG. 8 illustrates the top view of a three-channel(s) horizontal turbine rotor assembly, including positive feedback transmission; and

FIGS. 9A and 9B depict the end result of the transformation process, and a typical electric grid connected application.

### DETAILED DESCRIPTION OF THE INVENTION

Water has a density of 833 times that of our atmosphere (wind) and seems to be the technology to zero in on for an efficient renewable energy source. The goal is to recreate the earth's hydrodynamic eco-system in a portable containment system, and put a “water fall” (hydroelectric power plant) in every house, business, auto, train, and boat. This technology, when put into mass production throughout the world, will have global disruptive, but positive impact, on changing existing trillion dollar roadmaps toward moving the world's population to a distributed energy system that will significantly reduce our dependency on fossil fuels in record time.

This invention will dramatically change the world's energy roadmap, initially suppressing the need for further development of water, wind, and solar alternative present-day green renewable energy solutions, and over a much longer period of time will allow continental electrical distribution grids as we know them today to be dismantled and/or reduced to much smaller local city, town, urban area grids to handle high peak loads of undersized locally distributed equipment. The technology is in its infancy and is considered to be at the transistor stage of development and will spawn a new age of power generation technology and untold numbers of related industrial support jobs. It is expected that within a few years' time this technology will begin to be proliferated by homeowners through the world via a simple installation kit that hooks embodiments of the present invention to the home's electric meter or distribution box and onward to the grid. It is estimated that the size of the equipment will be no larger than the home's furnace.

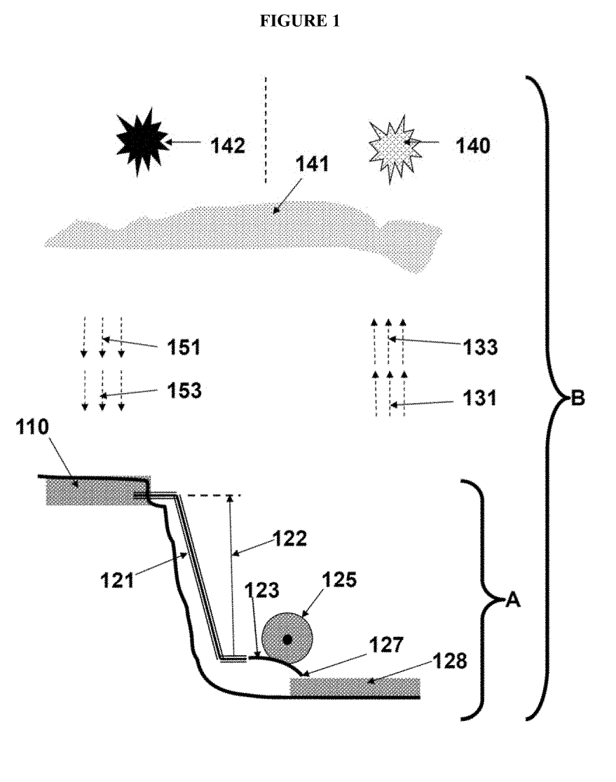

The overall objective of the present invention is to emulate the Earth's hydrodynamic eco-system reservoir replenishment process, and hydro power generation process, and to package the system in a semi-portable containment structure; i.e., that is to: (i) transform the 24 hours a day/ 7 days a week/ 365 days a year evaporation-condensation process of lifting a fluid from a lower level to a higher level; and (ii) transform the earthly process of harnessing the energy or power of gravity fueled falling fluid with a turbine, to a new set of processes that miniaturizes or shrinks the earthly processes, but produces the same energy or power as that of the typical waterfall, as given by Eq. 1-1 and as shown in FIG. 1:

Pa=rho*Q*g*h Eq. 1-1

Where: rho=fluid density in kg/m̂3; Q=mass flow rate in m̂3/s; g=acceleration of gravity in m/ŝ2, h=height of fluid to turbine in meters (m).

And to produce this amount of available power Pa, to drive a turbine, in a recursive process 24 hours a day/7 days a week/ 365 days a year, and put the energy or power generation of a waterfall in every commercial and military home, business, auto, train, boat, ship, and air vehicle.

It is a further objective of the present invention to start by hypothesizing the concept of a gravity multiplier n, where, as n is made very large, the quantity (n*g), i.e., artificial gravity, in the above equation gets very large, and for the same available power (Pa), the height (h) can be divided by the gravity multiplier (n), such that the quantity (h/n) gets very small. After this objective is accomplished, it would be a good start toward “shrinking” or miniaturizing the earth's hydrodynamic eco-system, and also a good start for minimizing the lifting or pumping process of getting fluid back to the reservoir, i.e., to a height of only (h/n) above the reservoir.

It is a further objective of the present invention to transition the hypothetical gravity multiplying process (that is not possible in our everyday stationary or inertial domain) into a process in the rotary centrifuge-like domain (where it is possible).

It is a further objective of the present invention to define the gravity multiplier n, as it is defined in centrifuge technology, such that the product of (n*g) is defined as artificial gravity, (i.e., the “fuel” for this system).

It is a further objective to ask and compare:
How much external energy or power does it takes to generate a radial gradient of artificial gravity across a partially submerged disc of radius r (say r equals 0.5 meters) with say 200 or 450 g′s at its circumference?
How much fluid dynamic energy-power is generated if a tube or penstock is embedded in the above partially submerged disc (later called funnel-shaped fluid distributor), where the fluid enters the tube or penstock at the center of the rotation, flows up through a slight incline through the above radial gradient of artificial gravity to a tangentially pointed nozzle located at radius r just above the reservoir surface that ejects the fluid in a direction opposite to the physical direction of the rotating disc and nozzle?

It is a further objective to show that the fluid dynamic power generated in the above process is a function of the observed velocity of the fluid and its mass flow rate given by Eq. 1-2, a shorthand notation of Eq. 1-1:

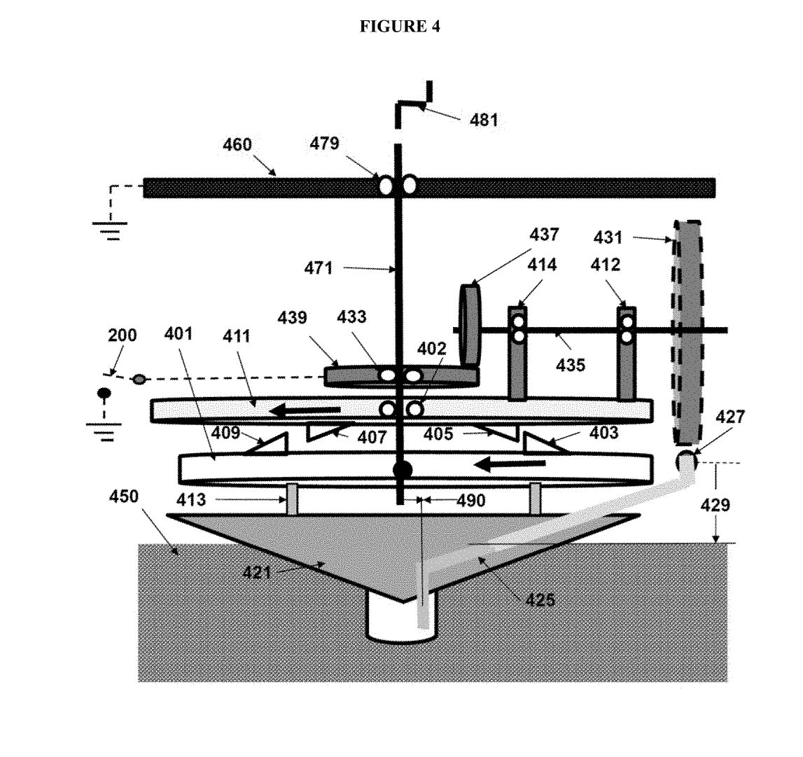

Pa=Mdot{kg/s}*½*V̂2{m̂2/ŝ}=½Mdot*V̂2{watts} Eq 1-2

Where: Mdot=rho{kg/m̂3}*Q{m̂3/s}=rho*Q{kg/s); and where V̂2=g {m/ŝ2}*h{m}=g*h{m̂2/ŝ2}

Where, the observed velocity (and thus the fluid dynamic power available) can be dramatically different depending on where it is being viewed or captured from.
From the viewpoint of our everyday stationary domain, the observed velocity of the fluid leaving the nozzle will be zero meters/second (nozzle continuously ejects a mass flow rate of fluid in a direction opposite to the physical direction of the rotating nozzle and there are no other pumping sources acting on the fluid, implying the observed or absolute fluid velocity will be close to zero meters/second). So, this implies, based on Eq. 1-2, if Vj is close to zero, there will be close to zero power produced from the viewpoint of our everyday stationary domain no matter how fast we spin the rotor with an external energy source. So, for our case of no other pumping sources acting on the fluid, the input power required to sustain the rotor assembly at any particular rpm does not depend on the amount of fluid flowing, it only depends on the mechanical power required to counteract bearing friction, aerodynamic drag, and the fluid dynamic drag of the partially submerged low drag funnel-shaped fluid distributor that houses the penstocks.
But in the centrifuge-like rotary domain, from the viewpoint of the rotating nozzle tip, the fluid velocity will be observed to be something close to the physical velocity of the nozzle tip, but in the opposite direction. So, the power available (Pa), in the form of the mass flow rate (Mdot) and velocity (Vj), jetting from the nozzle, as observed (and captured) in the rotary domain will be huge. (see FIG. 4 specifications and analysis)

It is a further objective to show that the power available (Pa) in the form of mass flow rate (Mdot) and velocity (Vj), at the nozzle tip, as observed from within the centrifuge-like rotary domain will be huge compared to the amount of input cranking energy or power it takes, in our everyday stationary domain, to sustain the rotors' rpm at say 600 or 900 rpm. Rpm is the parameter that is responsible for manufacturing the radial gradient of artificial gravity that develops g forces of 200 or 450 g's respectively across a partially submerged disc (later called funnel-shaped fluid distributor) of radius r at its circumference.

Note: # of g's=ŵ2*r/g=(2*pi*rpm/60)̂2*r/g=the #'s of g's above

Where: r=0.5 m; g=9.81 m/ŝ2; where operational rpm's are 600 & 900
Accordingly, if we can find a way to capture the fluid dynamic power that only exists in the centrifuge-like rotary domain (it's near zero in our everyday stationary domain), and if the power captured is much greater than the external input cranking energy or power used to sustain the rotor rpm at its operational frequency, then we can use a portion of the captured fluid dynamic power to totally replace the external supplied cranking energy and we will have created a self-fueling (where the fuel is artificial gravity), “artificial gravity fueled fluid dynamic generator/motor”.
Note: The concept of the term “artificial gravity as a fuel” should be permitted. It's analogous to natural gravity (g). It is an acceleration force measured in meters/sec/sec. In the power available (Pa=rho*Q*g*h) equation of falling water, g acts as a fuel that makes the water fall. Without it water wouldn't fall. It provides an acceleration force that operates on the fluid that converts potential energy (PE) into kinetic energy (KE). Also, Boeing Phantom Works and Lockheed

Skunk Works are pursuing fuel-less propulsion systems, and researched gravity fueled, and anti-gravity fueled propulsion systems for space travel. The phrase “gravity is a fuel that can be used but not consumed” was coined; it need not be combustible. More recently (2017) NASA has invested in an artificial gravity chamber and a fuel free engine to create a sci-fi like Mach Effect Thruster propulsion system for space travel that would produce thrust without the irreversible ejection of propellant, eliminating the need to carry propellant that would make space travel a reality. Based on these inputs from well-established organizations there is some precedence for a scientific acceptance of the term “artificial gravity as a fuel”.

It is a further objective to minimize the Coriolis force of a radial moving fluid whose momentum tries to follow a straight-line radial path within a straight radial penstock, yet we are rotating it and thus continually changing its radial orientation (azimuth) with respect to the radial flowing fluid passing through it.

It is a further objective to define the methods and processes for capturing and getting the fluid dynamic power out of the artificial gravity centrifuge-like rotary domain and into a stationary user friendly inertial domain.

It is a further objective to define a scalable family of artificial gravity fueled fluid dynamic generator/motor embodiments that produce power outputs, ranging from less than a kilo-watt to tens and hundreds of kilo-watts, and beyond.

FIG. 1 depicts the earth's hydro dynamic eco-system. When we talk about hydro power generation, as implementers and users of hydro power we generally only think about the system as pictured in the lower part of FIG. 1 identified as A.

FIG. 1A depicts hydro power generation from the perspective of an implementer. Is there a source of water or reservoir 110 at a higher elevation available to me, or can a dam be built to create one? Whether it is a major hydro power generation plant or a private micro-hydro power generation facility, the height 122 difference is the only thing that is and needs to be considered, will the reservoir 110 or stream be at an elevation above where it can be tapped into, will nature provide a sufficient quantity of water, and after it is used, can the waste water or tail water 128 find its way to the oceans? If the above conditions exist a hydro power generating facility can be built. The amount of energy or power available to the turbine is based on the flow rate of water 123 in the mostly vertical pipe 121 and its vertical distance or height 122 to its nozzle and turbine runner 125 as specified in Eq. 1-1 and Eq. 1-2 above. The amount of energy or power captured (Pc) by turbine runner 125 is based on its efficiency (eff) and is given by Pc=eff*Pa. After the turbine runner 125 captures the fluid dynamic power the energy depleted water 127 falls (using gravity) into the tail water 128 and eventually finds its way to rivers and the ocean.

FIG. 1B illustrates the bigger picture. There is an eco-system support process that replenishes the reservoir 110 that takes place. An external seemingly obscure source of energy, the sun 140, warms the surface of the earth and causes surface moisture/water to evaporate 131 into a vapor 133 state and form clouds 141 at high elevations. The warming of day by sun 140 and the cooling of the night 142, among other contributors, create winds that move the clouds 141 over land and cause condensation 151 resulting in precipitation (rain, sleet hail, snow) 153 to fall from high altitudes, well above the earth's surface, that eventually get into the liquid state and refill the reservoir 110.

The question posed that stimulated this invention was, “Can I synthetically emulate, in highly compressed time, the earth's hydrodynamic eco-system, house it in a portable containment structure, and put a “waterfall” and hydrodynamic energy generator in every house, auto, train boat, etc.”

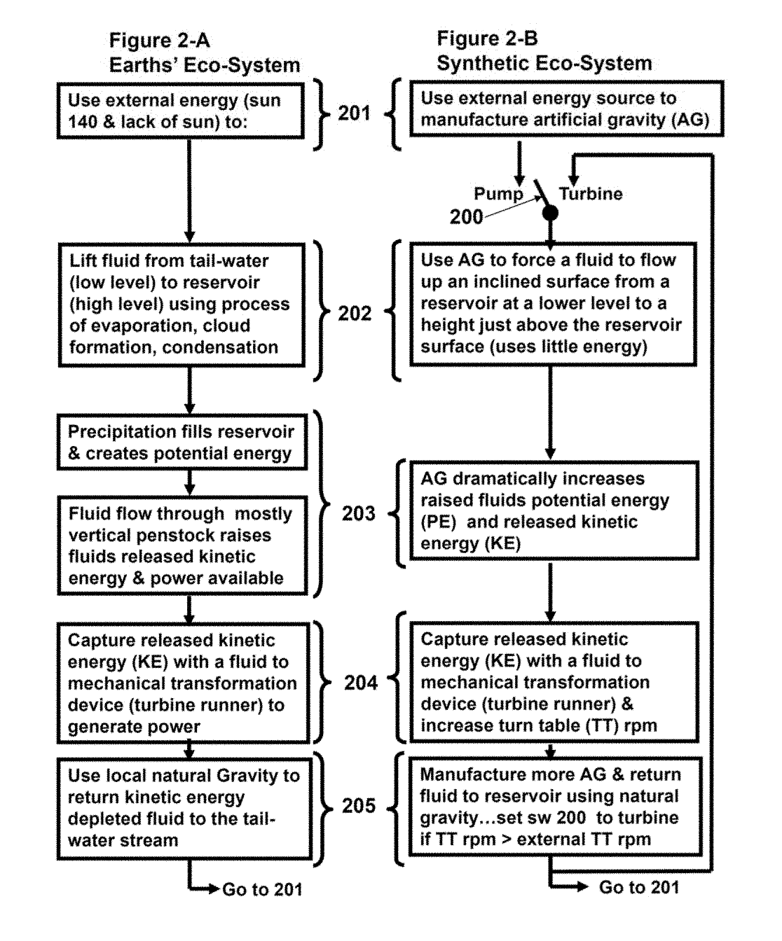

FIGS. 2A and 2B compare earth's hydrodynamic eco-system in FIG. 2A to the invention's method of transforming the earth's hydrodynamic eco-system to a synthetic eco-system, an artificial gravity fueled process in FIG. 2B and highlights the pertinent likenesses and differences.

Referring to Step 201, in FIG. 2A the earth's hydrodynamic eco-system uses an external energy source, the sun and lack of sun, to keep the natural reservoir replenished, and uses gravity (g) as the fluid dynamic fuel (the accelerating force) to transform the reservoir fluid's potential energy (PE) to kinetic energy (KE) to carry out the subsequent processes in FIG. 2A, whereas in FIG. 2B, the synthetic eco-system, uses an external energy source to manufacture artificial gravity, the fluid dynamic fuel or accelerating force that is used to initialize the rotor assembly's pumping function in the subsequent processes delineated in the remainder of FIG. 2B

Referring to Step 202, the earth's hydrodynamic eco-system in FIG. 2A, uses the sun 140 as a fuel to evaporate water and lift it high into the atmosphere in the form of a vapor to form clouds and condensation to form precipitation to fill a reservoir. The synthetic eco-system in FIG. 2B, uses artificial gravity that was manufactured in Step 201 to force fluid from a reusable reservoir of fluid, up an inclined surface to a height just above the reservoir surface (not into the atmosphere). The centrifuge-like rotary domain process of raising a fluid to a height just above the reservoir's surface from which it was taken, requires very little energy. It requires very little energy because, using centrifuge-like technology the small vertical distance that the fluid has to be lifted can be treated as head loss, which results in a minor fluid velocity degradation at the nozzle output, but saves an enormous amount of input energy or power if we had to use conventional pumping technology.

Referring to Step 203, the earth's hydrodynamic eco-system in FIG. 2A, uses precipitation to fill reservoirs at high elevations, creating potential energy (PE). This energy source is tapped into via a mostly vertical pipe and uses gravity as a fuel (an acceleration force) to transform the reservoir's potential energy (PE) to released kinetic energy (KE) at the turbine. Eq. 1-1 defines the power available as

Pa=rho*Q*g*h

The synthetic eco-system, FIG. 2B, uses artificial gravity as a fuel (the acceleration force) to dramatically increase the mass flow rate Mdot and velocity Vj of the fluid that is jetting from the nozzle. Eq. 1-2 defines the power available in this flowrate as:

Pa=Mdot*½*Vĵ2

Referring to Step 204, the earth's hydrodynamic eco-system in FIG. 2A, captures kinetic energy (KE) with a fluid to mechanical transformation entity such as a turbine runner. Based on the efficiency (eff) of the turbine runner the captured power (Pc) is given by Eq. 2-1

Pc=eff*Pa=eff*rho*Q*g*h Eq. 2-1

In the synthetic eco-system, FIG. 2B, both the reaction force and the impulse force of the kinetic energy KE are captured in an additive manner. The reaction force by pointing the released KE stream tangential to the rotor and in a direction to aid in spinning the rotor in its initial direction thereby increasing or sustaining the rpm of the rotor assembly thereby producing more or sustain current levels of artificial gravity production. And the momentum or impulse force with a fluid to mechanical transformation entity such as a turbine runner, that allows the impinging fluid to spin the turbine runner and its shaft in a direction that when the shaft is coupled to a positive feedback gear train, the impulse force of the fluid aids in rotating the rotor in its initialized direction, thus producing more or sustaining current levels of artificial gravity production. Based on the efficiency (eff) of the turbine the captured power (Pc) is given by Eq. 2-2

Pc=eff*Pa=eff*½*Mdot*V̂2 Eq. 2-2

So yes, the reaction and impulse forces are equal and opposite, but the turbine runner and positive feedback gear train combination act as a torque reverser to rotate the rotor in the same direction as the reaction force, in the initialized direction of rotation.

Referring to Step 205, the earth's hydrodynamic eco-system uses natural gravity (an acceleration force) to return the kinetic energy depleted fluid to the tail water stream. The synthetic eco-system in FIG. 2B, uses the captured reaction and impulse forces in Step 204 to aid in rotating the rotor in its initial direction thereby increasing or sustaining the rpm of the rotor assembly thereby producing more or sustaining current levels of artificial gravity production, before it returns the energy depleted fluid to the reusable reservoir under natural gravity conditions. The process continues (go back to Step 201 ) using external energy, until the captured released KE in Step 204 exceeds the input energy required to sustain rotor assembly rotation.
Note: Artificial gravity increases exponentially with only linear changes in rpm as does the captured fluid dynamic power (Pc). So, at some high rpm, if we accept the statement in the objectives for the moment, stating that the input cranking energy or power to rotate the rotor, does not depend on the amount of fluid flowing, only on the bearing friction, the aerodynamic drag, and on the drag of a partially submerged fluid distributor, then the closing sentence in the above paragraph makes sense. See FIG. 4 detailed specifications and analysis.

Once the captured kinetic energy (KE) in Step 204 exceeds the input energy required to sustain rotor assembly rotation, the Euler Switch 200 (in later discussions a ratchet) engages signifying that the ongoing centrifuge-like rotary domain artificial gravity fueled fluid dynamic pumping process now produces enough captured fluid dynamic power (Pc) in the form of mass flow rate (Mdot) and velocity (Vj) to replace the external cranking energy or power the self-fueling turbine mode or cycle in FIG. 2B is entered and repeats endlessly; where each cycle tries to manufacture more artificial gravity in reference Step 205 which increases the fluids Mdot and velocity Vj in reference Step 203.
Note: No laws of physics or thermodynamics are broken. Once the captured kinetic energy (KE) in Step 203 exceeds the input energy required to sustain rotor assembly rotation a self-fueling process takes place. This is not perpetual motion, the self-fueling process must be continuously controlled to prevent rpm runaway and self-destruction within a matter of seconds (definitely not perpetual motion) and controlled in such a manner that the breaking load does not cause the rpm to fall below the self-fueling rpm threshold that will instantly stop the process (also not perpetual motion)

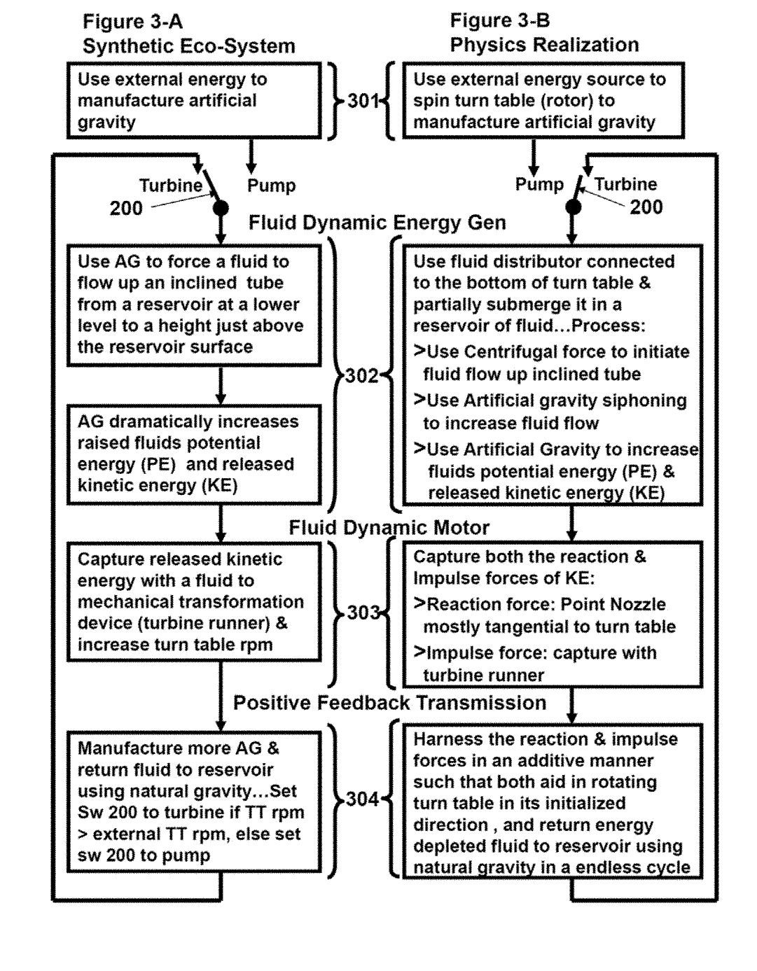

The ensemble of processes described above with reference to FIG. 2B, are the roots of the present invention. These processes will be further developed and expanded upon in the description of FIGS. 3A and 3B and in the rigorous performance analysis that aids in the description of FIG. 4.

FIGS. 3A and 3B - Uses the synthetic eco system developed in FIG. 2B as a reference starting point to develop a more rigorous physics and fluid dynamics based foundation to each process discusses so far. FIGS. 3A and 3B also move from the eco system phraseology onto more appropriate artificial gravity fueled fluid dynamic energy generator/motor phraseology. To that end FIGS. 3A and 3B add fluid dynamic energy generator, fluid dynamic motor, and positive feedback transmission, headings to different groups of identified entities and processes in FIG. 2A to correlate the synthetic eco system processes to motor/generator phraseology.

Referring to Step 301, the entities and processes of FIG. 3A illustrate that an external energy source is used to manufacture artificial gravity. If we relate this to how this would be implemented in a physics realization, FIG. 3B, one could initiate the spinning of a disc or turntable faster and faster to manufacture increasing amounts of centrifugal force measured in Newtons (N) and artificial gravity measured in meters per second squared (m/ŝ2). As soon as spinning begins both of these parameters increase exponentially with only linear increases of the turntable's radian frequency (w) as can be observed in equations 3-1 & 3-2 respectively.

centrifugal force (CF)=m(V̂2)/r=m(w*r)̂2/r=m*ŵ2*r{N} Eq. 3-1

Angular velocity Eq. w=V/r; so, V=w*r

Since centrifugal force and artificial gravity are related, and we know the force due to gravity is F=m*g we can combine the two force equations to get the relationship between the radius (r), the rate of rotation (w) and artificial gravity (g) by setting the right-hand side of both equations equal to each other;

So: m*g=m*ŵ2*r; and solving for g we get Eq. 3.2

artificial gravity (AG)=(ŵ2*r) {m/ŝ2} Eq. 3-2

Where: w=2*PI*f

It is also convenient to normalize Eq. 3-2 by dividing the right side of the artificial gravity equation by g to obtain a dimensionless number (n) to determine the number of g's contained in that number as defined in Eq. 3-3.

n=ŵ2*r/g=ŵ2*r/9.81 Eq. 3-3

Where: g=9.81{m/ŝ2}

### Fluid Dynamic Energy Generator

Referring to Step 302, the processes of FIG. 3A, associated with using centrifugal force to force fluid to flow up an inclined surface from a reservoir at a lower level to a height just above the reservoir surface, and to use artificial gravity to increase the raised fluid's potential energy (PE), and released kinetic energy (KE) is formalized further in FIG. 3B. Referring to Step 302, FIG. 3B illustrates undisputable physics and fluid mechanics based solution to accomplish the cited objectives, and that is to preferably hard couple a fluid distributor to the turntable and to partially submerge the fluid distributor into a reservoir of fluid such that the input port is totally submerged at or near the center of rotation, and the output port is located just above the reservoir surface just beyond the turntable's circumference. Once rotation of the turntable with its partially submerged fluid distributor begins to rotate, 100% of the centrifugal force (CF), and artificial gravity (AG) that was manufactured under Step 301 above is coupled to the fluid causing:
First, CF forces fluid to flow from the center of rotation toward the circumference of the fluid distributor and thus “primes” or fills the fluid distributor.
Once fluid begins to flow out the orifice, artificial gravity begins to aid fluid flow by a process called artificial gravity siphoning and for large values of artificial gravity (AG), artificial gravity (AG) dominates the fluid flow process.
The main function performed by AG is to dramatically increase the fluid's mass flow rate Mdot and its velocity (Vj) and thus its released kinetic energy (KE).

The above processes now have Physics and Fluid Mechanics roots, and if we observe the overall functionality of these processes, in motor/generator terms, the functionality of the sum of these processes define the fluid dynamic energy generator portion of the present invention.

### Fluid Dynamic Motor

Referring to Step 303, the process in FIG. 3A is to capture and transform the kinetic energy stream into mechanical rotational energy, as is done in conventional hydro power generation systems. In FIG. 3B the process of FIG. 3A is defined in terms of realizable physics and fluid dynamics principals. As summarized in the figure and immediately below, both components of the released kinetic energy (KE), the reaction force, and the impulse force of the fluid stream are captured.
Reaction force is captured by pointing Nozzle mostly tangential to turntable.
Impulse force is captured with a water wheel or more precisely a turbine runner whose buckets or spoons pass through the fluid stream defined above.

The above summarizes how the particular processes described in reference number Step 303, originally associated with the synthetic eco system, relate to the physics and fluid dynamic processes of the fluid dynamic motor.

### Positive Feedback Transmission

Referring to Step 304, the initial processes identified in FIG. 3A are to manufacture more artificial gravity and return the raised energy depleted fluid back to the reservoir. In the more rigorous based physics/fluid dynamics solution in FIG. 3B , we describe a plan to harness both the reaction force and the impulse force of the KE stream in an additive manner, such that both aid in spinning the turntable in its initialized direction thereby manufacturing more artificial gravity, using it in Step 302 to increase the fluid's released kinetic energy, capturing the reaction and impulse force in Step 303, harnessing both forces in Step 304, after which the energy depleted fluid is returned back to the reservoir using natural gravity in an endless cycle of self-fueling. This is not perpetual motion, the self-fueling process must be continuously controlled to prevent rpm runaway and self-destruction within a matter of seconds (definitely not perpetual motion) and controlled in such a manner that the breaking load does not cause the rpm to fall below the self-fueling rpm threshold that will instantly stop the process (also not perpetual motion)

FIG. 4 represents the initial concept of a physical embodiment of the subject artificial gravity fueled fluid dynamic energy generator/motor. It's partitioning and functionality follow almost exactly the functionality that was developed in FIGS. 2 and 3. From FIG. 4, all the physics and fluid dynamic objectives set forth in this disclosure are addressed in terms of classical physics and fluid mechanics engineering principals.

The lower portion of FIG. 4, the portion directly below stationary platform 460, defines the entities involved with the core physics and fluid dynamic technology portion of this invention.
a main bearing 479 and vertical shaft 471 connected to the stationary platform 460;
a sun gear 439 loosely coupled via bearing 433 to the vertical shaft 471
a generator rotor 411 loosely coupled by bearing 402 to the vertical shaft 471;
a set of bearing supports 412 and 414 hard coupled to generator rotor 411;
a turbine runner 431 connected to the drive shaft 435;
a drive gear 437 connected to the drive shaft 435 meshed to sun gear 439;
a notional Euler switch 200
connected to sun gear 439 that allows the sun gear to freewheel or be locked to a stationary reference;
a generator rotor 401 hard connected to the vertical shaft 471;
a fluid distributor 421 hard coupled to generator rotor 401 via supports 413;
where said fluid distributor 421 includes a plurality of penstock(s) 425 including an associated nozzle(s) 427 configured to propel a fluid from a reservoir 450 to the turbine runner(s) 431;
where in wedge cam 403 drives wedge cam 405 during the initialization process, and wedge cam 407 drives wedge cam 409 during the fluid dynamic power generation process.

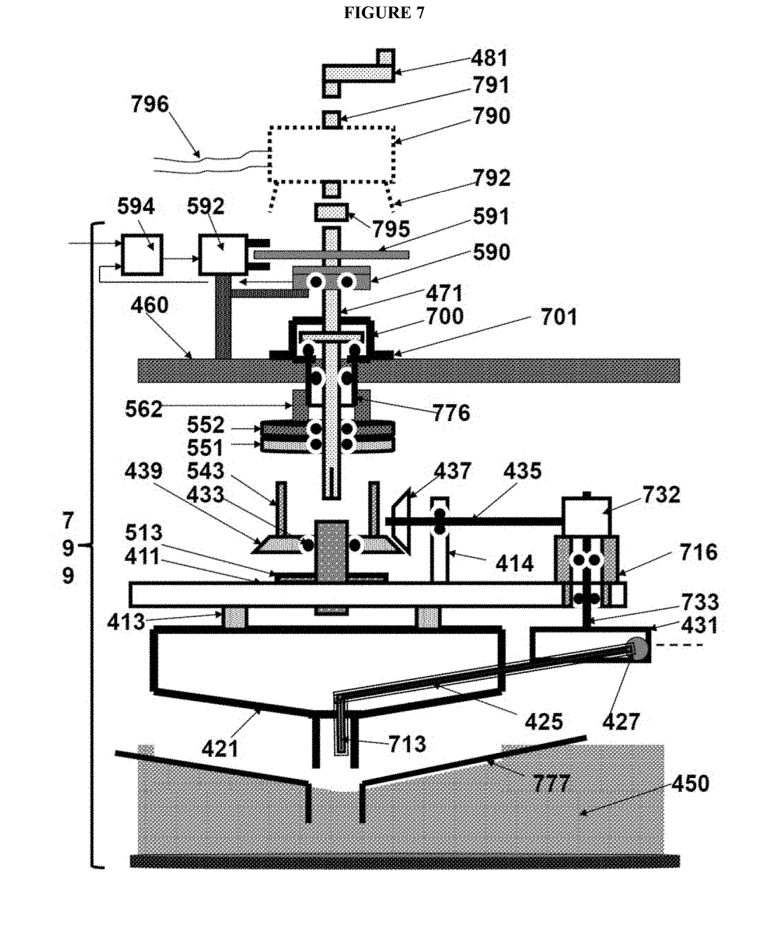

The upper portion of FIG. 4, above stationary platform 460, defines the “application specific” portion of the invention. This includes:
a system control and brake entity;
a variable speed (rpm) to constant speed (rpm) coupling entity (this was identified in original filing as a simple one to one (1:1) coupling 795—FIG. 7;
a commercial off the shelf (COTS) electric generator entity.

### System Operation

Referring to FIG. 4, a crank 481 is symbolically used to provide input energy to the system from an external source. The crank's input energy or power begins to rotate shaft 471 that passes through stationary platform 460 via a low friction bearing 479 and provides the input energy or power to rotate the entire rotor assembly via its hard connection to the generator rotor 401 and that rotor's connection to the motor rotor 411 via the wedge cams 403-405 connection depicted in the bottom half of FIG. 4.

From the fluid's perspective, input mechanical energy rotates the entire rotor assembly including its partially submerged low drag funnel-shaped fluid distributor 421 faster and faster toward some predetermined operational rpm. Centrifugal force, artificial gravity, and syphoning action act on the continuous supply of water in the penstocks 425 (they are partially submerged) forcing the water to flow outward toward the circumference (a typical centrifuge process) where it is allowed to exit the fluid distributor just above the reservoir surface via the plurality of tangentially aimed nozzles 427, first as a drip, then as the rotor rpm is accelerated faster, as a continuous stream, and finely as it approaches its final operational rpm as a continuous jet Vj of water from each nozzle 427.

### Startup vs. Sustaining Energy

The startup input energy or power is relatively large. It has to do with the moment of inertia of the rotor assembly, and the amount of kinetic energy required to accelerate the rotor assembly from standstill or zero rpm to its final operational rpm and is given by:

KE=½ I ŵ2 where I=½ m R̂2 See Analysis Eq. 4.8 & 4.9

This is important information, but once the rotor is at its operational rpm, the amount of input energy to sustain its rotation at that rpm is what is important. In a frictionless and drag free environment, if fluid were not flowing, it would be zero, but we don't have such an environment. The point is it should be some small fraction of the startup input energy or power. Enough to overcome the friction and drag forces, and any other forces associated with a partially submerged rotor. Our approach to this is to first estimate what fraction of the total KE is required to sustain rotor assembly rotation without fluid flow, where the sustained kinetic energy (KEs) without fluid flow is given by:

KEs=(x %) KE See statement after Eq. 4.9

Then, perform an analysis on fluid flow that takes place within and around the rotor assembly, and calculate how much extra input energy it takes to spin the entire rotor assembly when Vjet and Mdot are jetting out the plurality of nozzles 427, and add this result to the KE required to sustain rotor assemble without fluid flow to estimate the total energy or power required to sustain rotor assembly rotation at its operational rpm.

### Mechanical Operation before Fluid Flow

As shown in FIG. 4, in the initial concept per the discussion with respect to FIGS. 2 and 3, there are two rotors, a fluid dynamic generator rotor 401 and a motor rotor 411. The generator rotor is hard coupled to the vertical (I/O) shaft 471, and the motor rotor 411 is loosely coupled to it via bearing(s) 402.

During the initialization process vertical I/O shaft 471 provides external cranking energy to the hard-coupled generator rotor 401 and its attached fluid distributor 421 via supports 413. As soon as the generator rotor 401 begins to spin, wedge cam 403 which is hard coupled to the generator rotor 401 pushes against wedge cam 405 which is hard coupled to the motor rotor 411, thereby forcing motor rotor 411, that houses the turbine runner 431, its drive shaft 435 and drive gear 437 via bearing supports 412 and 414 that are hard coupled to the motor rotor 411, all to rotate in lock-step with the generator rotor 401 around I/O shaft 471 as does the sun gear 439 due to its connection (meshed teeth) to the non-spinning drive gear 437 (no fluid flow turning turbine runner 431 yet). This fact together with sun gear's 439 loose coupling via bearing 433 to vertical I/O shaft 471, and the ratchet being in its freewheeling mode (schematically shown as Euler Switch 200 open) force the sun gear 439 to be dragged around the I/O shaft 471 in lock step with the generator rotor 401.

### Mechanical Operation with Fluid Flow

When fluid dynamic power begins to jet out from nozzle 427, turbine runner 431 begins to spin, forcing the hard-coupled drive shaft 435 to spin, forcing drive gear 437 to spin and put a torque on the sun gear 439 and thus spins the loosely coupled (via bearing 433) sun gear 439 in a direction to slow it down and reverse its direction of rotation around vertical I/O shaft 471. As the sun gear 439 tries to go through zero rpm detected by Euler switch 200 (a ratchet based solution) the sun gear 439 is locked to a stationary reference stationary platform 460 that then forces the drive gear 437 to use its torque and its connection to the motor rotor 411 via bearing supports 412 and 414 to initially aid in pulling the motor rotor 411 around the now stationary sun gear 439. Then even as more external cranking energy is applied to vertical I/O shaft 471, the generator rotor 401 continually dominates in rotating motor rotor 411 via wedge cams 403 and 405 while the generator rotor's 401 hard coupled fluid distributor 421 (via supports 413) manufactures exponentially increasing amounts of fluid dynamic power for only linear changes in rotor assembly rpm.

Finely, for a properly scaled system, at some rpm lower than the operational rpm, the fluid dynamic power captured by the turbine runner 431 exceeds the external input cranking power to spin the rotor assembly and the motor rotor 411 begins to spin faster than the generator rotor 401, thereby disengaging wedge cams 403 and 405 and engaging wedge cams 407 and 409 and thereby takes over the task of rotating generator rotor 401 (including the fluid distributor 421) and ultimately vertical I/O shaft 471 to which the generator rotor 401 is hard coupled to.

This now completes the overview of how the core technology of this breakthrough invention works. Before discussing the application specific stuff above stationary platform 460, we shall jump into the physics and fluid dynamic analysis that supports the above operation.

### Estimating Vj et, its Mass Flow Rte Mdot, and Power Available Pa

### Estimating Vj Relative to Nozzle Tip

In the above rotating system, there are two components of pressure acting that govern the flow of water through the centrifuge-like fluid distributor 421. A normal operating head (Hn) is created due to the physical distance between the water level in the penstock and the vertical distance to its nozzle measured in meters. For our case, where the water initial level is slightly below the turbine runner 431, this results in a small negative head. The second head is a centrifugal head (Hc) created due to the angular speed (w) of the penstock 425 and its radius (R), as external cranking energy is applied to the rotor assembly vertical I/O shaft 471, and is equal to (ŵ2*R̂2)/2 g meters.

Since we're looking to relate head to velocity we look to the kinetic energy equation of the water flow and see that Vj is related to the sum of the normal operating head and the centrifugal head as expressed in Eq. 4.1

½ m Vĵ2=m g (Hc−Hn) Eq. 4.1

By solving for Vĵ2 and eliminating like terms that appear on both sides of Eq. 4.1 we get Eq. 4.2

Vĵ2=2 g (Hc−Hn)=(ŵ2*R̂2)−(2 g*Hn) Eq. 4.2

We can now solve for Vj by taking the square root (sqrt) of both sides of Eq. 4.2 to obtain Eq. 4.3

Vj=(Sqrt(ŵ2*R̂2)−(Sqrt 2 g * Hn)=(w*R)−( Sqrt(2 g * Hn) Eq. 4.3

To get a feel for how the magnitude of the two components of velocity in Eq. 4.3 vary with rotor rpm, lets pick some typical operational values that represent our first product for the identified parameters and solve for Vj

Let g=9.8 say 10 m/ŝ2; Hn=0.1 m; w=(2 PI) * (rpm/60); rpm=900; R=0.5 m By substituting these values into Eq. 4.3 we get Eq. 4.4

Vj=(2 PI*rpm/60) (0.5)−(Sqrt 2*10*0.1) Eq. 4.4
For rpm=600:Vj=(PI*600/60)−(Sqrt 2)=(31.4−1.4)=30.0 m/s
For rpm=900:Vj=(PI*900/60)−(Sqrt 2)=(47.1−1.4)=45.7 m/s

Thus far we have calculated the velocity of the water leaving the orifice of the rotating nozzle as seen by the rotating nozzle 427.

### Estimating Mass Flow Rate Mdot

The mass flow rate Mdot of water flowing through the nozzle 427 is given as a product of the relative velocity Vj in m/s, the total nozzle exit area A in m̂2 of the nozzle, and the density of water rho in Kg/m̂3. Equation 4.5 states this in equation form:

Mdot=rho*A*Vj kg/s Eq. 4.5

To get a feel for the magnitude of Mdot in Eq. 4.5 as a function of rotor rpm, let's use the velocities calculated in Eq. 4.4, pick a nozzle orifice area, and use the nominal density of water, to solve for Mdot.

Let rho=1000 Kg/m̂3, A=1̂2 inch=1/1600 m̂2

By substituting these values into Eq. 4.5 we get Eq. 4.6

Mdot=(1000) (1/1600) (Vjet)=(5/8) (Vjet) Eq. 4.6
For 600 rpm Mdot=5/8*30.0=18.7 kg/s
For 900 rpm Mdot=5/8*45.7=28.5 Kg/s

### Estimating Power Available Pa

The fluid dynamic power available Pa in this jet of water is given by Eq. 4.7

Pa=Mdot (kg/s)*½(Vj)̂2 (m̂2/ŝ2)=Mdot *½*(Vj)̂2 W Eq. 4.7
Dimensional analysis check: (kg*m/ŝ2) N*m=Joule*1/s=Watts
Where Joule is the energy or work done by water; Joule*1/s is Watts

By substituting the values calculated above in Eq. 4.4 and Eq. 4.6 into Eq. 4.7 we get the one channel (1 Ch) power available Pa result for rotor speeds of 600 rpm and 900 rpm in the table below. For rotor balance purposes two or more channels are required. For rotor real estate economy and robustness we picked 3 channels minimum and 6 channels maximum.

TABLE 4.1
Per-Channel Power available Pa in rotary domain

| | | 1 Ch | 3 Ch | 6 Ch |
|---|---|---|---|---|
| For 600 rpm | Pa = 18.7 * ½ * 30.0\hat{ }2 = | 8.41 kw | 25.2 kw | 50.4 kw |
| For 900 rpm | Pa = 28.5 * ½ * 45.7\hat{ }2 = | 29.7 kw | 89.2 kw | 178.4 kw |

It should be noted that the values calculated for Vj, Mdot, and Pa are relative values, relative to the tip of a nozzle that is rotating at either 600 rpm or 900 rpm. The power available (Pa) is manufactured in the centrifuge-like rotary domain and therefore must be captured in the rotary domain with rotary domain referenced turbine runners 431. The 3 and 6 channel power available Pa numbers are obtained by multiplying the 1 Ch numbers by 3 and 6 respectively. No laws of Physics or Thermodynamics have been broken. So far, we only used external energy to spin the rotor to generate the fluid velocity Vj and the mass flow rate Mdot of the fluid jetting from the nozzle that results in the power available numbers listed in table 4.1 above.

### Estimating the Cranking Energy or Power

### Startup Without Water Flow

So now let's determine how much external input “cranking” energy or power is required to bring the rotor assembly 401 and 411 rpm from rest up to its operational rpm and how much cranking 481 energy or power is required to sustain that rpm. Let's first do this without water flow (a fictitious case), to get a baseline, then calculate the amount of extra energy required to support Vj, Mdot, and the power available Pa outputs listed in Table 1

The amount of cranking energy or power required to bring the rotor assembly 401 and 411 rpm from rest up to its operational rpm without water flow is a function of the rotor assembly 401 and 411 moment of inertia. Looking ahead, let's assume a lumped element cylindrical mass, as that is the configuration of our production model. For a cylindrical mass, the moment of inertia is given in Eq. 4.8, where the values of each parameter for our example 3 and 6 channel system are provided above it.

Let: m=3 Ch mass of rotor (32 kg) plus mass of fluid (3 kg) @ final rpm, R =0.5 m

I=½*m*R̂2=½(35) (0.5*0.5)=17.5 (0.25)=4.375 Kg m̂2 Eq. 4.8a

Let: m=6 Ch mass of rotor (44 kg) plus mass of fluid (6 Kg) @ final rpm; R =0.5 m

I=½*m*R̂2=½/₂ (50) (0.5*0.5)=25 (0.25)=6.25 Kg m̂2 Eq. 4.8b

Once we know the moment of inertia, we can estimate the amount of input energy required to accelerate the rotor assembly 401 and 411 from zero rpm to its final rpm via Eq. 4.9 for our 3 and 6 channel system.

KE=½*I*ŵ2=½*4.375 (4*9.86*100)=8,627 joules or watt*sec Eq. 4.9a

Where w=2*PI*(rpm/60; rpm =600

KE=½*I*ŵ2=½6.25 (4*9.86*225)=27,758 joules or watt*sec Eq. 4.9

Where w=2*PI*(rpm/60); rpm=900

### Cranking Energy to Sustain Rotor Rotation

Once the rotor assembly 401 and 411 is at its operational rpm the amount of energy required to keep it at that rpm would be zero in a frictionless and drag free environment, but we don't have that situation, so we must therefore supply enough cranking energy to overcome the bearing friction, and rpm dependent aero-dynamic drag forces acting on the rotor assembly 401 and 411 plus the fluid-dynamic drag forces acting on the partially (minimally) submerged low drag shallow funnel-shaped fluid distributor 421 that constitutes the lower portion of the rotor assembly 401 and 411. For now, let's assume the energy required to sustain the rotor at any operational frequency to be 5% of its KE, so for the above examples:

For 3 Ch it is 5% of 8,627 =431 joules or watt*sec; or power P =431 w

For 6 Ch it is 5% of 27,758 =1,387 Joules or watt*sec, or power P =1.38 kw

### Estimating Extra Input Energy when Vj and Mdot Flowing

So now let's see how much extra external input energy it takes to spin the rotor assembly 401 and 411when Vj and Mdot are jetting out the nozzle 427 to produce the available power Pa listed in Table 1. To estimate the cranking energy or power required to produce that available power, we need to relate Vjet and Mdot to our every-day stationary or absolute coordinate system. From Kinematics, the absolute velocity of the water emanating from a tangentially rotating nozzle is given by the vector Equation 4.10

Vabs=Vnoz+(−Vjet)=Vnoz Vjet=Vnoz−Vj Eq. 4.10

In the above vector equation, the physical velocity of the nozzle 427, Vnoz, is taken as the positive direction of rotation (clockwise for our implementation) and is the only rotation mechanically allowed by the system. Vjet is aimed tangentially but in a direction opposite to the direction of the rotating nozzle 427 and therefore its velocity is defined to be negative.

To get a feel for the per-channel magnitude of Vabs and its behavior or trend as a function of the two-operational rpm's we are considering, let's represent the above velocities in terms of rotational angular velocities (as we did for Vjet above) and plug these values into Eq. 4.10

The component values of Vj; i.e. (wR−Sqrt 2*g*Hn) for 600 rpm and 900 rpm that were used in Eq. 4.4 to calculate Vj are used below for Vj to calculate Vabs. (Note: that the component signs in the substitution below have been adjusted/reversed for direction of flow per Eq. 4.10 above).

For 600 rpm

Vabs=Vnoz−Vj=(w*R)−(w*R−Sqrt 2)=31.4−31.4+1.4=1.4 m/s

Where Vnoz =w*R=2*PI*(rpm/60)*0.5=31.4

For 900 rpm

Vabs=Vnoz−Vj=(w*R)−(w*R−Sqrt 2)=47.1−47.1+1.4=1.4 m/s

Where Vnoz==w*R=2*PI*(rpm/60)*0.5=47.1

The resulting values for Vabs for the two-operating rpm's we are considering are identical. It tells us that no matter how fast we spin the rotor, the per channel absolute fluid (water) velocity Vabs is only related to the negative head or height 429 between the reservoir 450 and the nozzle orifice 427, (Vnoz and the centrifugal head wR cancel) as indicated in the two equations immediately above, no matter how fast we rotate the rotor.

The per channel kinetic energy KE of this head loss is nil as indicated below in Eq. 4.11 compared to the kilo-watts (kw's) of power available at the output of each nozzle in the form of Vj and mass flow rate Mdot.

KE=½*Mdot*Vabŝ2=½*0.875*1.96=0.857 Joules or 0.857 Watts Eq. 4.11

Where Mdot=(1000 kg/m̂3) (Vabs) (Anoz)=1000*1.4*1/1600=0.875 kg (1/s)

Where Vabs=1.4 m/s, Anoz=1/1600 m̂2, Vabŝ2=1.4̂2 m̂2/s2

So, from an energy input (cranking 481) perspective, since the absolute velocity Vabs of the water stream(s) that exit the nozzles are close to zero or nil for all operational rotor rpm's, they require no additional cranking 481 energy or power and the rotor assembly 401 and 402 is said to act like a solid mass as we presumptuously assumed at the beginning of this section, he net input cranking 481 energy or power required to sustain rotor assembly 401 and 411 is only the power to overcome the bearing 479 friction, aerodynamic drag, and the fluid dynamic drag forces acting on the rotor assembly 401 and 411 for the 3 channel and 6 channel embodiments as calculated above, (431 W and 1.38 kw respectively), at the beginning of this section even though, from the nozzle(s) or from within the centrifuge-like rotary domain perspective there is a huge fluid dynamic velocity Vj and mass flow rate Mdot jetting from the nozzle(s) 427. This phenomena was observed and reported by Daugherty in 1954, Leo in 1960, Duncan in 1970, and by Cross Pipe Turbine author Elsevier in 2009 but each of the authors must have been so focused on reaction turbines, that they failed to pursue the relevance of this phenomena. They all viewed the phenomena as an operating point to be avoided because the reaction power output that they were trying to maximize as viewed in our everyday stationary or inertial domain is zero when this condition occurs. This invention independently rediscovered this phenomena and found a way to capture and harness this power within the centrifuge-like rotary domain, where it was generated, by using turbine runners 431 mounted to rotor 411 via bearing supports 412 and 414 that provide the rotary domain referencing necessary to capture the mass flow rate (Mdot) and fluid velocity (Vj) jetting from nozzle 427. There are no Laws of Physics or Thermodynamics broken in the above analysis or embodiment, we just reinvented what others observed and found a way to harness it.

### Dealing with Euler Coriolis Force

According to Euler, when we rotate a fluid around an axis, as in an impeller, or in our case radial penstock(s) 425, the external energy required to overcome the momentum of fluid that is trying to follow a straight-line radial path within the penstock to the circumference, as we rotate or continually change the radial orientation (azimuth) of a radial or straight penstock(s) around its axis of rotation, takes a significant amount of energy. We are continually bending the fluid momentum force via the fluid's contact with the ever-changing position of the penstock 425 walls. This energy acts contrary to the cranking energy supplied to crank 481 and can be reduced to near zero in our application by changing the notional radial penstock to a radial curved (partial spiral) penstock. It should be noted that for our near zero head or height 429 application, there is always a fixed relationship between the velocity (Vj) of the fluid jetting from the nozzle(s) 427 and the physical rotational velocity of the rotor assembly 401 and 411.

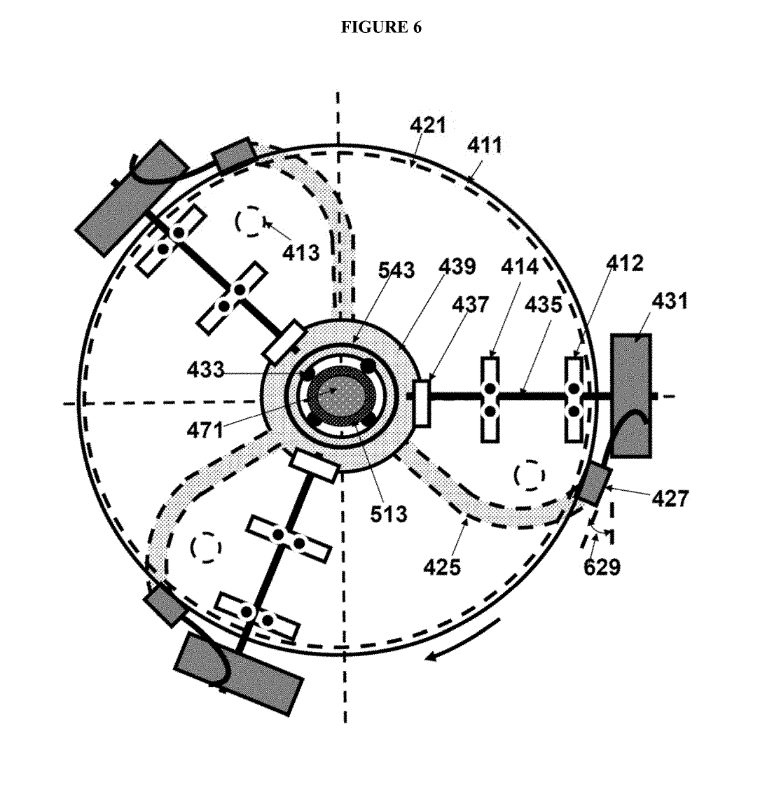

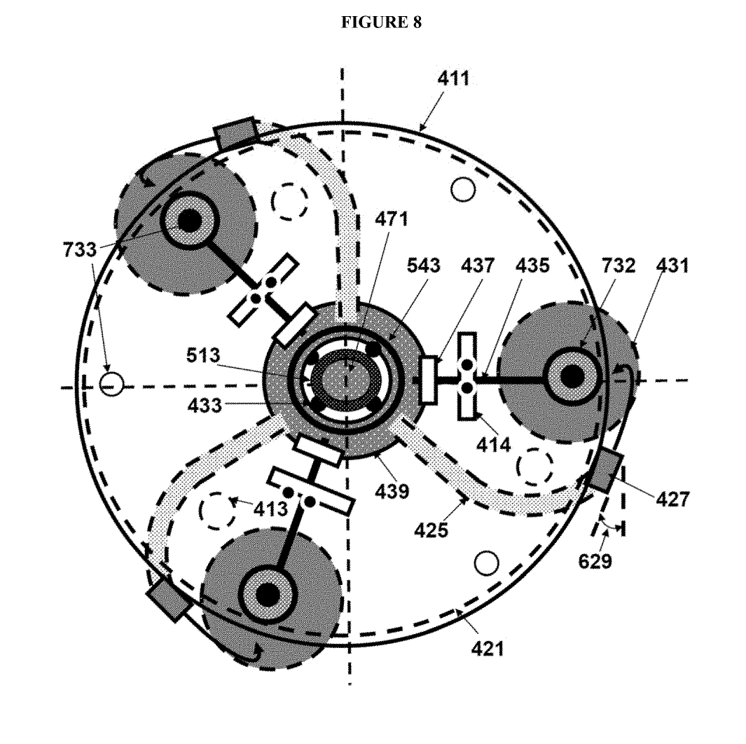

By curving the penstock(s) 425, from its normal radial direction, beginning at its point of entry at radius (rl) 490 into the horizontal rotating domain, outward to a point on the circumference of the rotor assembly 401 and 411 that is moving toward the normal radial (had the penstock(s) not been curved), at a rate such that a fluid particle in the curved penstock flows unperturbed (along a streamline) in its natural radial direction without ever encountering a wall of the continually rotating penstock 425 until it exits rotor assembly 401 and 411 tangentially via nozzle(s) 427, thereby keeping the external rotational forces primarily to those described earlier, i.e., main bearing 479 friction, plus atmosphere drag, plus fluid dynamic drag that are all very small. It should be noted that the specification descriptions of FIGS. 6 and 8 further elaborate this fundamental concept.

### Capturing Vj & Mdot and Positive Feedback Transmission Overview

Since Vj and Mdot are manufactured in the rotary domain (initially by using external cranking energy to rotate the rotor and thus the plurality of partially submerged penstocks), they must be captured in the rotary domain. This is done with a plurality of turbine runners 431 (one for each nozzle), where each turbine runner 431 is mounted to the rotating generator rotor 411 and aligned with its respective nozzle 427, such that Vj, the water velocity, impacts the turbine runner 431 at its optimum spot and angle of attack. The turbine runners 431 transform the mass flow rate Mdot jetting from the nozzles 427 at velocity Vj, i.e., they transform the available power Pa at the nozzle 427 output, into rotational mechanical power. The transformation efficiency for the Turgo-type turbine runners 431 we are using (an advance version of the Pelton-type turbine runner) easily achieves 80% efficiency.

Table 4.2 summarizes the fluid or hydro dynamic input available power (Pa) to rotational mechanical output power using the conservative 80% turbine efficiency for the 1, 3, and 6 Channel cases. If we subtract out the amount of input cranking power to sustain the rotor rpm at its operational frequency using the moment of inertia Eq. 4.8 and kinetic energy Eq. 4.9 and use our assumed 5% number as the amount of kinetic energy required to sustain rotor rotation, we are left with the power available to drive the load (an electric generator) as listed in Table 4.2 below:

TABLE 4.2
Per-Channel Power available Pa in rotary domain

| | | 1 Ch | 3 Ch | 6 C |
|---|---|---|---|---|
| For 600 rpm | Pa input | 8.41 kw | 25.2 kw | 50.40 kw |
| | Pwr out | 6.72 kw | 20.16 kw | 40.32 kw |
| | Pwr to sustain rotor assy. rotation | | .43 kw | 1.38 kw |
| | Pwr captured to drive load | | 19.72 kw | 38.94 kw |
| For 900 rpm | Pa input | 29.7 kw | 89.1 kw | 178.2 kw |
| | Pwr out | 23.76 kw | 79.8 kw | 141.6 kw |

| | | |
|---|---|---|
| Pwr to sustain rotor assy. rotation | .43 kw | 1.38 kw |
| Pwr captured to drive load | 79.37 kw | 140.22 kw |

The results listed in Table 4.2 are representative performance parameters of our initial product. The results are intended to show that the rotational mechanical power required to sustain rotor assembly rotation at its operational rpm is small compared to the large amount of mechanical output power delivered to the vertical I/O shaft of an electric generator. It clearly reveals the self-fueling nature of this technology. And the presented performance analysis behind the numbers in Table 4.2 clearly shows that no laws of physics or thermodynamics have been broken!

### Rotor Diameter, Turbine Runner Diameter, and Gear Ratios

Throughout the discussion of FIG. 4 we have used a consistent set of numeric examples each contributing to the overall definition and understanding of the invention disclosed herein. We shall carry that idea forward in a parameterized fashion relating the turbine runner 431 and positive feedback gear ratios, back to rotor 411 diameter that was previously specified in the discussion of FIG. 4 as one meter (1 m) for the embodiments specified in this disclosure.

The turbine runner 431 diameter was chosen to be approximately one sixth (⅙) the diameter of the rotor 411 diameter, allowing for up to six turbine runners 431 to be mounted symmetrically in either a vertical or a complainer fashion on the rotor 411, each having its buckets or spoons pass through the rotors' perimeter where the penstock nozzles 427 are located.

An equally important choice for the one sixth (⅙) ratio was we want the no-load turbine speed to be about 6 times that of the rotor speed. Since the rotor is traveling at a physical velocity of wR, and since there are no other pumping processes on going, the fluid velocity jetting from nozzle 427 is also approximately wR in the opposite direction (its wR minus the small head-loss velocity we described earlier). There are several ways to account for this loss, first we could ignore it (we're really not interested in the no-load speed) or we could be pragmatic and pick a turbine runner diameter that is slightly smaller by say 4% (velocity head-loss at 600 rpm is approximately 5% and at 900 rpm is 3%), that will boost the turbine runner 431 rpm up toward the theoretic value of 6 times wR (3600 rpm or 5400 rpm) for the slightly degraded velocity (negative head loss) of fluid that is jetting from nozzle 427 and impinging on the turbine runner 431.

As stated above we're really not interested in the no-load rpm of the turbine runner 431, we're interested in driving a load with the drive shaft(s) 435 of the turbine runner 431, where the magnitude of the load is adjusted to provide a resisting torque on the turbine runner shaft that will slow the turbines' circumference velocity or rpm down to one half the velocity of Vj which is 1800 rpm or 2700 rpm respectively for 600 and 900 rpm operation.

So, if we choose a turbine runner 431 pitch diameter of 6.5 inches, and adjust it by 3% down in size we're looking at a 6.3 inch pitch diameter turbine runner 431. To make it simple, if we choose a drive gear 437 diameter of 1 inch, we will have a torque increase of 6.5:1 per turbine runner. Since the loaded turbine runner rpm's are running at 3 times the operational speed or rpm of the rotor 411, the sun gear diameter needs to be 3 times the diameter of the drive gear or 3 inches, allowing the drive gear 437 to make 3 revolutions for each rotor 411 revolution.

### Application Specific Hardware

The application specific hardware above stationary platform 460, is listed below and depicts the kind of hardware that is required to control the rotor assembly depicted below stationary platform 460 and connect it to an electric generator.

System Control and Brake Entity
The system control and break entity allows user to preset an operational rotor assembly 401 and 411 rpm. It then continually monitors the vertical I/O shaft 471 rpm and via a control loop either applies no breaking force to allow the rotor assembly to slew to some higher rpm or applies breaking force to slow it down and or to keep it at the preset rpm.

Coupling
Earlier it was believed that the coupling 795 entity was strictly a means of hard coupling the vertical I/O shaft to an electric generator shaft.
Instead of a straight through coupling, we could replace the coupling 795 with an elliptic gear train having a ring gear, a planet carrier containing 3 planet gears and a sun gear, where the vertical I/O shaft 471 connects to the planet carrier and the electric generator shaft 791 (FIG. 7) connects to the sun gear, while the ring gear is held stationary. This coupling approach with either a 6 to 1 or 4 to 1 gear ratio would allow 600 rpm and 900 rpm products to drive 3600 rpm electric generators.

Electric Generator
Commercial off the shelf (COTS) electric generator is the baseline.

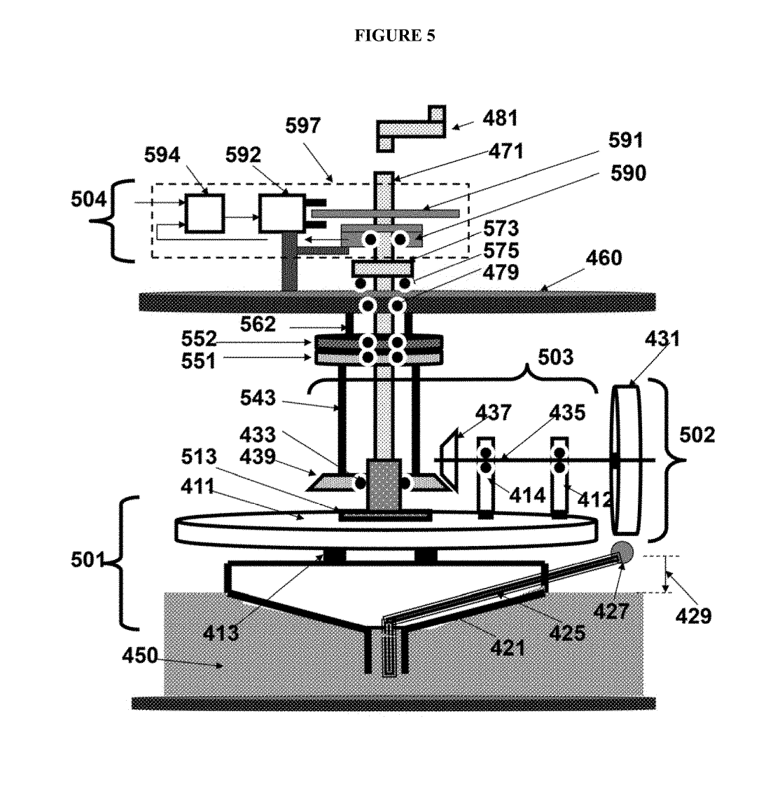

FIG. 5, illustrates a single rotor embodiment (vertical turbine) of artificial gravity fueled fluid dynamic energy generator/motor controlled by a closed loop braking entity 597 which includes controller 594, disc brake 592, brake disc 591, and shaft encoder 590. The single rotor embodiment is a simplified, less general version, of FIG. 4.

Referring back to FIG. 4 for the moment, FIG. 5 was obtained by melding the generator rotor 401 into the motor rotor 411 of FIG. 4 by moving the generators rotor 401 hard connection to vertical I/O shaft 471 to the motor rotor 411 thereby eliminating bearing 402 (add to FIG. 5) I can't . . . I′m talking about FIG. 4. This transformation totally enables the motor rotor 411 to handle the combined functionality of the generator rotor 401 (not shown on FIG. 5) I can't . . . I′m talking about FIG. 4 and motor rotor 411 without the need for wedge cams 403, 405, 407, and 409, and from now on we will refer to this multitask rotor as the rotor 411

Referring back to FIG. 5, in operation, assume the entire system is at rest. We engage the crank 481 (crank is for illustration purposes only and represents an external energy source) to the vertical I/O shaft 471 and begin supplying increasing amounts of external rotational energy to the vertical I/O shaft 471 rotating it faster and faster in the clockwise (CW) direction (alternatively in the counter clockwise (CCW) direction, but then all future references to theses directions need to be reversed), where the shaft is supported in the vertical direction by shaft collar 573 and thrust bearing(s) 575 to the stationary platform 460 of the fluid dynamic energy generator/motor. The vertical I/O shaft 471 is further supported by bearing 479 for rigidity in the horizontal or axial directions before it passes through ratchet assembly 552 & 551, (the Euler switch 200 in FIGS. 2 and 3) and into the hub 513 to which it is preferably hard coupled. The hub 513 in turn is preferably hard coupled to rotor 411 and thus rotor 411 begins to rotate faster and faster in unison with the cranking 481 force, at the same frequency of rotation and in the same clockwise (CW) direction.

### Fluid Dynamic Energy Generator 501

The above process of rotating the Rotor 411 in the clockwise (CW) direction immediately begins the process of manufacturing artificial gravity (AG) and centrifugal force (CF), the two inseparable “fuels” that are used within the fluid dynamic portion of this invention. Both of these fuels grow exponentially (actually a square law growth) with linear increases in frequency (0 or rpm of the rotor 411.

Gradients of CF and AG, are manufactured by the rotating rotor 411 and these gradients increase exponentially (actually a square-law relationship) with linear frequency changes in rotor 411 rotation.

By hard coupling, via supports 413 a fluid distributor 421 to rotor 411, nearly 100% of the manufactured CF and AG that is manufactured by the rotor 411 is coupled to the fluid distributor that is partially submerged in a reservoir 450 of fluid and to any fluid submerged within the mostly radial penstock 425 At some frequency (f), CF will begin to noticeably force, and constantly replenish, fluid in the submerged portion of penstock 425 to flow up its slightly inclined surface toward its circumferential end nozzle 427 to a height (h) 429 just above the reservoir surface but sufficient enough to be in line with the circumferentially located bucket center of turbine runner 431.

As the frequency of rotation is increased further CF fills the penstock 425 with fluid, and as the frequency is increased further yet, a steady stream of fluid emerges from the nozzle 427 and a new phenomenon of up-hill artificial gravity siphoning begins to aid the CF in fluid flow process. The fluid distributor's 421 external shallow funnel shape is designed to present a low drag force that otherwise would not be present if the penstock 425 had to be dragged through the fluid.

Simultaneously, with the aforementioned fluid flow process, the fluid's velocity emanating from the nozzle 427 begins to increase, where the power available (Pa), from this flow is given by Eq. 4-3 developed in the description of FIG. 4:

Pa=½*rho*Q*v̂2 Eq. 4-3

Where v2=2*(n*g)*r; v=Sqrt v̂2=vj; Q=v*Anoz; rho=1000 Kg/M̂3.

So, by substitution and transformation into the artificial gravity (AG) domain Eq. 4-3 becomes:

Pa=(½)*rho*(vj*Anoz)*(2*(n*g)*r) Eq. 5-1

### Fluid Dynamic Motor 502

The fluid dynamic motor captures the released kinetic energy (KE) from the nozzle 427 on the circumferential end of the radially curved penstock(s) 425 and, in an additive manner, captures both the reaction force and the impulse force of the KE stream emanating, from nozzle 427. The reaction force of the KE stream is constructively captured because its nozzle 427 is pointing tangential to the Rotor 411, but in the opposite direction to the rotating rotor 411, thus the reaction force of nozzle 427 is in the direction to aid in spinning the rotor 411 in its initialized direction.

The impulse force of the KE stream is captured with a fluid to mechanical transform entity, known in the fluid dynamics field, as a turbine runner 431. The particular types of turbine runners 431 that fit this application are the Pelton and Turgo style of turbine runners. These types of runners extract energy from the momentum or impulse of a moving fluid, and are perfectly suited to act as a rotary domain referenced turbine runner(s) 431. Bearing supports 412 and 414 provide that referencing via their hard coupling to the rotor 411. In operation the impulse force of the KE jet of fluid, jetting from the nozzle(s) 427, strikes the rotary domain referenced turbine runner(s) 431 at or near its circumference, spinning the turbine runner(s) 431 and its drive shaft(s) 435 and drive gear(s) 437 that is meshed with a now stationary (ratchet locked to stationary reference) sun gear 439. The sun gear 439 now acts as a roadway, and the drive gear(s) 437 act as a wheel on the roadway pulling rotor 411 around the sun gear 439 in its initialized direction.

The Pelton and Turgo types of turbine runners are designed to handle the mass flow rate (Mdot) and velocity of fluid (Vj) that jets out from nozzle(s) 427. They have a bucket/spoon geometry designed to provide maximum power transfer when the load on the drive shaft(s) is adjusted such that the turbine runner(s) 431 rotates at ½ the velocity of fluid (Vj) jetting from nozzle 427.

### Positive Feedback Transmission 503

For a desired power output per fluid dynamic channel, the positive feedback transmission adjusts the speed ratio between the rotor 411 and turbine runner 431 such that at any given rotor rpm, the rotor 411 manufactures enough artificial gravity (AG) to support a nozzle 427 jet of fluid velocity (Vj), two times that of the turbine runner 431 bucket/spoon velocity. The turbine runner 431 diameter and two positive feedback transmission gears, the drive gear 437 and the sun gear 439, control this ratio.

As an aside, during start-up the sun gear 439 that is loosely coupled to hub 513 via bearing 433 is free to rotate CW by its connection to the free-wheeling ratchet 551 via sun gear hub extension 543 that is preferably hard coupled to sun gear 439. During start-up the sun gear 439 rotates in lock step with the rotor 411 because the drive gear is not yet spinning, i.e., no fluid flowing or no fluid flow strong enough to brake static friction of the turbine runner 431 and the positive feedback transmission (parts under parenthesis 503, up through half of the ratchet assembly 551). It does this by the drive gear's connection to drive shaft 435 and its connection to bearing supports 412 and 414 that are hard coupled to the rotor 411 that is being rotated by external cranking 481 energy or power. At higher frequencies of rotation, the kinetic energy of the jet of fluid (Vj) jetting from nozzle 427 becomes strong enough to break static friction of the turbine runner 431 and associated positive feedback transmission. At this point the drive gear 437 begins to spin and the yet unrestrained sun gear sun gear 439 begins to slow down, from the view point of the stationary platform 460. As more and more external cranking energy or power is applied the rotor 411, spins faster and faster manufacturing exponentially increasing amounts of artificial gravity and fluid dynamic power in the form of mass flow rate (Mdot) and velocity (Vj) that jets from nozzle 427 to the point that the sun gear 439 tries to go from CW rotation through zero rotation and thus reverse it's apparent direction of rotation as observed by the ratchet assembly 551 & 552 that is referenced to the stationary platform 460 via its connection hub 562, at which point this condition is detected by the ratchet assembly 551 & 552, and the sun gear 439 via sun gear hub extension 543 is locked to a nonrotating stationary platform 460.

At this point, the real power generation process begins. The drive gear 437 now exerts a force on the now nonrotating sun gear 439 and the drive gear 437 now begins to rotate around the sun gear 439, causing the rotor 411 to be forced to rotate around the sun gear (via the drive gear's connection to the rotor 411 by bearing supports 414 and 412) and faster than it had been rotating with just external cranking 481 energy or power being supplied to vertical I/O shaft's 471 connection to the rotor 411 via hub 513. The bottom line effect of this is the rotor 411 begins to rotate at a slightly faster rotational rate or rpm than the external energy source 481 is rotating it, thereby incrementally incrementing artificial gravity, which increases the kinetic energy jet of fluid velocity (Vj) and mass flow rate (Mdot) of fluid emanating from nozzle 427, which causes turbine runner 431 to capture more fluid dynamic power and increase its circumferential velocity, which causes the drive gear 437 to speed up causing the rotor 411 rpm to incrementally increase, in an recursive cycle, eventually attaining a rotational speed or rpm that transforms enough fluid dynamic power to mechanical rotational power; enough to completely replace the external cranking energy or power 481 that it took to get the rotor 411 to this rpm and energy producing transformational state.

From the above discussion, if the rotor 411 is left unloaded without a braking force applied to its vertical I/O shaft 471, it will within a matter of seconds, be self-accelerated to a huge rpm and catastrophically damaged. To prevent this, the fluid dynamic motor/generator needs to have a braking load commensurate with the torque or horsepower that it develops as a function of the rotor's 411 rpm, applied to its output vertical I/O shaft 471.

### Controlling the Fluid Dynamic Motor Speed 504

The depicted closed loop braking system entity 597, comprised of shaft encoder 590, the braking system controller 594, the disc brake 592 and the brake disc 591 that is affixed to the vertical I/O shaft 471 provides a practical solution to control the fluid dynamic motor/generator's rotor 411 rpm. The closed loop control braking system can be used as a standalone braking load on the fluid dynamic motor/generator as depicted in 504, or as a control function when the fluid dynamic motor/generator is driving via vertical I/O shaft 471 an electric generator 790 via coupling 795 as depicted in FIG. 7.

In either case, before any external rotation energy source is activated, an operating rpm is loaded into the braking system controller 594 and the braking system controller recognizes that the rotor is going too slow (it is stopped at this point in time) and it commands the disc break 592 to releases the braking applied to break disc 591. As increasing amounts of external cranking 481 rotational energy are applied to the rotor 411 via vertical I/O shaft 471, the rotor 411 begins to rotate faster and faster, and eventually attains a rotational speed or rpm that completely replaces the external energy source 481, at which time the external energy source 481 is disengaged, and the fluid dynamic motor/generator via its positive feedback transmission continues driving the rotor 411 faster and faster each cycle manufacturing more and more artificial gravity, increasing the released KE until the rotor 411 rpm, as detected by the shaft encoder 590, begins to approach the preset rpm. The system controller 594 then begins commanding disc brake 592 to put a breaking force on the brake disc 591 that is preferably hard coupled to vertical I/O shaft 471 slowing the vertical I/O shaft 471 towards its preset rpm using at a minimum, a 2^{nd} order control loop. The system controller 594 then forces some overshoot but then quickly commands the breaking to cause the vertical I/O shaft 471 to hover around its preset rpm. Optionally, if the disc brake 592 were outfitted with a sensor that measured brake force on the brake disc 591, torque and horsepower at any operational speed can be calculated. The above described control function is baseline, i.e., set the rpm and the fluid dynamic motor will run at that rpm providing any external load on the output shaft stays within the fluid dynamic power capability for that rpm setting; the control loop braking function will preferably adjust the amount of braking to maintain the preset rpm.

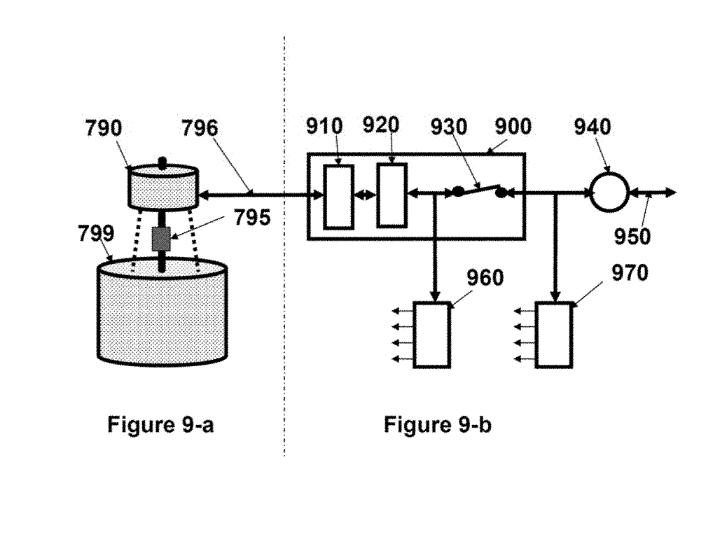

As an alternate, the control loop can be programmed to track large load variations by dynamically adjusting the rpm of the fluid dynamic motor/generator. For instance, the system controller 594 could dynamically increase or decrease the preset reference rpm based on the magnitude of the step change in rpm sensed by shaft encoder's 590 input to system controller 594. If the step change in rpm is larger than normal static load fluctuation, while the disc brake 592 breaking as usual is decreased or increased depending on the direction of the step change in rpm, and the fluid dynamic motor/generator is allowed to slew up or down toward the old reference rpm as sensed by the system controller 594, while the controller 594 modifies the previous reference rpm up or down based on the direction of the step change, and again in a continuous manner, commands the disc brake 592 to either increase its braking force when the measured rpm as determined by shaft encoder 590 begins to exceed the new reference rpm or decrease disc brake 592 breaking force when the rpm falls below the new reference rpm, and thus forces the rotor 411 to quickly hover around the new dynamically adjusted desired rpm. This function is used in applications where the fluid dynamic motor/generator rpm is isolated from the application end user required rpm by either inverter as depicted in FIGS. 9A and 9B or other mechanical methods that allow the fluid dynamic motor's vertical I/O shaft 471 rpm to operate at a different rpm than the crank 481 rpm. Again, if the disc brake 592 were outfitted with a sensor that measured brake force on the brake disc 591, torque and horsepower at any operational speed can be calculated.

FIG. 6, shows a top view of the rotor 411. It shows the penstock(s) 425 as dashed as they are housed below rotor 411 in the fluid distributor 421 which is hard coupled to rotor 411 via support(s) 413. The nozzle(s) 427 connects to the curved penstock(s) 425 within the fluid distributor and are mounted to the fluid distributor 421 tangential to its circumference. The turbine runner(s) is secured to rotor 411 via drive shaft 435 that is supported by bearing supports 412 and 414 that are hard coupled to rotor 411. The drive gear(s) 437 is meshed to sun gear 439 that is housed on a machined portion of the rotor hub 513 via the sun gear's internal bearing assembly 433. This method of housing the sun gear 439 allows the sun gear to stay connected to the rotor 411 and meshed with the drive gear even when the vertical I/O shaft is disconnected from the rotor's hub 513.

The above described permanent, but loosely connected the sun gear 439 via its internal bearing assembly connections to the rotor 411 are important for two reasons, first the connections allow the entire rotor assembly to be assembled, tested and balanced at the factory, and stocked and sold separately for a variety of applications; and second the connections allow the sun gear 439 to be controlled by a ratchet (not shown in this view) via hub 543, by allowing the sun gear 439 to free-wheel in lock-step with the rotor 411 or spin slower than the rotor 411 in the same CW direction during the initialization process, or be locked to a stationary reference in the power generation mode.

In the power generation mode the sun gear 439 is locked to a stationary reference via its hub 543 connection to the ratchet, and the drive gear(s) 437 which is driven by turbine runner(s) 431 via drive shaft(s) 435 uses the sun gear as a roadway to pull the rotor 411, via bearing supports 412 and 414, around the now stationary sun gear 439. Initially only aiding the external cranking energy or power in rotating the rotor 411 and vertical I/O shaft 471 to which the rotor 411 is hard coupled to via hub 513. In the power generating mode each rotational cycle of the rotor 411 incrementally increases the rotor's rpm, and thus the amount of artificial gravity produced and therefore the amount of fluid dynamic power available (Pa) jetting from nozzle(s) 427 in the form of mass flow rate (Mdot) and velocity (Vj). This power available (Pa) is captured by turbine runner(s) 431, spinning it faster and with more power captured (Pc), causing the drive gear(s) 437 to rotate around the rotor faster and faster with each rotor 411 cycle.

### Fluid Distributor

The fluid distributor 421 is a molded funnel-shaped device that houses the penstock(s) 425 and nozzle(s) 427. It is hard coupled to the bottom of rotor 411 via supports 413. The supports align the fluid distributor 421 in azimuth such that the fluid stream that jets out from a plurality of equally spaced nozzle(s) 427 strike the buckets or spoons of turbine runner(s) 431 at the optimal angle of attack 629 as specified by the turbine runner 431 manufacturer for optimal energy or power recovery of the mass flow rate (Mdot) and velocity Vj) jetting from nozzle 427.

To minimize the Coriolis force that acts contrary to the cranking energy, the penstocks 425 are curved in a partial spiral contour from point of entry near the center of rotation toward the circumference of the fluid distributor 421, where the fluid exits tangential to the rotor 411, but displaced 1 radian (approximately 60 degrees) for a penstock cross sectional area to nozzle cross sectional area ratio of 1 to 1, 120 degrees for a 1 to 2 area ratio, 180 degrees for a 1 to 3 area ratio, in a curved partial spiral contour that the fluid would have traversed had it not been contained in a penstock(s) 425

### Positive Feedback Transmission

The positive feedback transmission is comprised of drive shaft 435, drive gear 437, sun gear 439, plus ancillary bearing supports 412 and 414 preferably hard coupled to Rotor 411. The sun gear 439 via its hub-like connection 543 to a ratchet assembly (not shown in this view) either allows the sun gear 439 to free-wheel (spin in the clockwise direction) when the fluid dynamic power jetting from nozzle(s) 427 is nonexistent or not powerful enough for the turbine runner(s) 431 to spin the drive gear 437, or be locked to a stationary reference, as controlled by that ratchet when the fluid dynamic power emanating from nozzle 427 is powerful enough to sustain drive gear 437 rotation.

To allow this dual mode operation, the sun gear is loosely coupled via its internal bearing 433 to hub 513 that is hard connected to vertical I/O shaft 471. So, in operation, when the fluid dynamic power is not powerful enough to spin the drive gear 437 the stationary drive gears drag the sun gear 439 around in lock step at the rotor 411 rpm. As the rotor 411 rpm is accelerated faster by external cranking energy applied to vertical I/O shaft 471, the fluid dynamic stream jetting from nozzle 427 becomes powerful enough to spin the turbine runner 431 and drive gear 437 in a direction to slow the sun gear down (its rpm) compared to rotor 411 rpm. As the rotor 411 rpm is accelerated further, the fluid dynamic power spins the turbine runner 431 and drive gear 437 fast enough so as to try to reverse the direction of rotation of the sun gear 439, which the ratchet assembly (not shown in this view) prevents by locking the sun gear 439 to a stationary reference via its connection to the sun gear 439 via hub-like extension 543.

The locking of the sun gear 439 to a stationary reference signifies the beginning of the power generation mode. Initially the fluid dynamic power captured by turbine runner(s) 431 aids the external cranking energy by spinning the drive gear faster, but now since the sun gear is locked to a stationary reference, it can't spin so the drive gear(s) 437 uses the sun gear 439 as a roadway and thus causes the rotor to spin faster and faster with each revolution of the rotor 411; thus contributing more and more fluid dynamic power with each revolution of the rotor 411 until the captured fluid dynamic energy or power at some high rotor 411 rpm exceeds that of the external cranking energy or power causing the rotor 411 rpm to exceed the energy or power supplied by crank 481 and thus the captured fluid dynamic energy or power that is transmitted to drive gear(s) 437 spins the rotor 411 by using the stationary sun gear 439 as a roadway to pull rotor 411 around the sun gear 439 thereby spinning and providing output power to vertical I/O shaft 471 via its hard connection to hub 513 which is hard coupled to rotor 411. This takeover process is sensed by the crank in FIG. 5, and thus it disconnects itself from the vertical I/O shaft 471 thereby allowing the captured fluid dynamic power in the form of a mass flow rate (Mdot) and a velocity (Vj) to supply the centrifuge-like rotary domain captured power Pc =eff*Mdot*½Vĵ2 to drive the rotor 411 around the stationary sun gear 439 via the drive shaft 435 connection to bearing supports 412 and 413 that are hard connected to rotor 411 which is hard connected to hub 513 which is hard connected to vertical I/O shaft 471.

### Define Reference System . . . Power Generating Analysis

Before we discuss power generation, let's restate a few facts about the amount of input cranking 481 energy or power that is required to initialize the rotor 411 with rotation from rest at zero rpm up to its operational rpm. From the analysis presented in the specification discussion of FIG. 4 it should be noted that no matter how fast we spin the rotor 411 and its attached fluid distributor 421, the fluid velocity and fluid dynamic power produced as viewed from our everyday stationary or inertial domain is zero. This is because, for the near zero head centrifuge-like pumping process described, the fluid velocity jetting from nozzle 427 is nearly equal to but opposite in direction to the physical velocity of the nozzle 427. Near zero velocity in the power available equation Pa =Mdot*½ V̂2 implies near zero power available no matter what the mass flow rate (Mdot) is.

Since there is no fluid dynamic power generated or consumed as viewed in our everyday stationary there is no additional energy or power required from the stationary domain cranking 481 input to support fluid flow at any rpm. This discovery is a fundamental to the operation of this invention. The one other fluid dynamic parameter that could affect the amount of input power required to spin the rotor 411 is the Coriolis force or fluid momentum of fluid in penstock(s) 425 that normally acts contrary to the cranking energy 481 when straight radial penstocks are used. In the subject invention this force is minimized (or nearly zeroed out) by the radial curved penstocks and thus requires a minimal amount of extra input cranking 481 energy or power to rotate the rotor 411 if any, as described and discussed in FIG. 4 specifications and below.

The bottom line is the only cranking 481 energy or power required to rotate the rotor 411 from rest at zero rpm to its final operational rpm is the energy or power required to rotate the physical mass of the rotor 411 (which includes the constant mass of fluid that resides in the rotor at its operational rpm) and is given by the kinetic energy equation: KE =½*I* ŵ2, where I=½*m*R̂2 as defined in equations 4.8b and 4.8a respectively for our reference system. Once the rotor 411 is at or near its operational rpm, the amount of energy or power required to keep it at that rpm would be zero in a frictionless and drag free environment, but we don't have that situation, so we must overcome the main bearing friction and rpm dependent aero-dynamic drag forces acting on the rotor and the fluid dynamic drag forces acting on the partially (minimally) submerged low drag funnel-shaped shaped fluid distributor 421 a small fraction of the initialization energy. For our reference system we estimated the sustaining energy or power to be 431 watts. Even if it were double or triple or even quadruple this it is small compared to the power available (Pa) content of the mass flow rate (Mdot) and velocity (Vj) jetting from nozzle 427.

The energy or power available (Pa) that can be developed in an artificial gravity centrifuge-like environment is specified by Eq. 5.1:

Pa=(½)*rho*(vj*Anoz)*(2*(n*g)*r) Eq. 5-1

Where: (2*(n*g)*r)=Vĵ2

Defining a reference system with the following parameter transformed into SI notation:

r=0.5 m

f=600 rev/min*1 min/60S=10 rev/s f̂2 =100

Pi=3.14156

n=(ŵ2*r)/g=(62.83̂2*0.5)/9.81=(1973)/9.81=201.2

Vj=w*r=62.83*0.5=31.41; and Vĵ2=986.5

Anoz=1in̂2*0.00064516 m̂2/in̂2=0.00064516 m̂2

rho=1000 Kg/m̂3

So, by substitution, the per channel power available is:

$$Pa = rho * ( vj * Anoz ) * 1 \text{/} 2 ( Vj \hat{} 2 ) = 1000 * ( 31.41 * 0.00064516 ) * 1 \text{/} 2 \; 986.5 = 20.26 * 493.2 = 9.994 kw \text{/} ch$$

$$For 3 Turbine Runners = 29.9 kw$$

It should be noted that the per channel power available (Pa) number of 9.994 and thus the three-channel power available (Pa) number of 29.9 kw are a little larger than what was presented in the revised analysis of FIG. 4. The reason is, in the revised analysis we took into account the slight negative head loss associated with lifting the fluid to a height just above the reservoir surface, whereas when we submitted the previous patent application we did not include this refinement.

The amount of external energy or power required to spin the rotor is primarily the energy required to overcome the bearing friction within the main bearing vertical shaft assembly (not shown in this view), plus the aero-dynamic drag of the rotor 411, plus fluid dynamic drag of the partially submerged shallow funnel shaped fluid distributor 421. The Coriolis force is minimized (or nearly zeroed out) as described in the description of FIG. 4 by radial curved penstock(s) that in theory, for the centrifuge-like pumping process described herein, allow a particle of fluid in the penstock(s) 425 to flow in a true radial stream line that never intersects the sidewalls of the rotating penstock. What this implies is the momentum of the fluid flowing in the penstock has minimal impact on the amount of energy or power required to sustain the rotor 411 at any operational rpm. Based on all of the facts above, the external input energy or power to sustain rotor 411 rotation at any operational rpm (once it is at that rpm) is very, very small (1 to 2 kw estimated) compared to the fluid dynamic power being generated (29.0 kw) at the reference systems operational rpm (600 rpm) and forms the basis of the present invention.

FIG. 7 titled, embodiment of artificial gravity fueled fluid dynamic motor (horizontal turbine) driving electric generator is shown as an embodiment in the form of an exploded view to help highlight the concept of sub-assemblies, and its producibility and maintainability. From this figure and its discussion, one of ordinary skill in the art would appreciate that all of the sub subassemblies defined below are directly applicable to the vertical turbine configuration previously discussed in FIGS. 5 and 6, and applicable to other turbine configurations not discussed in this disclosure.

### General Description

FIG. 7 shows the main bearing vertical shaft assembly 700 including the vertical I/O shaft 471, which have mechanical interfaces both above and below the stationary platform 460. Parenthesis 799 defines the core artificial gravity fueled technology and embodiment of this invention. It represents a revolutionary new breakthrough in power generation technology.

### Above Stationary Platform

FIG. 7 shows stationary platform 460 supporting the main bearing vertical shaft assembly 700 by a flange. The vertical I/O shaft 471 protruding from the top of the main bearing 700 and stationary platform 460 is a stepwise tapered shaft (common in precision shaft design) with its largest diameter passing through the main bearing 700 that employs a tapered spline just prior to each step and a threaded segment just after the step over which the electronic shaft encoder 590 is inserted and secured to the vertical I/O shaft via a threaded nut, then at the next stepwise taper the brake disc 591 is attached via the next tapered spline and secured via a threaded nut. The electric generator 790 stands on legs 792 secured to stationary platform 460 and is attached via its shaft 791 via a tapered spline segment, to the vertical I/O shaft 471 last tapered spline segment, by coupling 795 that mates the two shafts together. The notional mechanical cranking energy 481 input can be supplied manually, via an external motor, or by generator 790 acting as a motor to initialize the coupling 795 with rotational motion (rpm), before enough artificial gravity fueled fluid dynamic power is generated from within the core artificial gravity fueled technology and embodiment 799 to turn electric generator 790 motor function back into a generator function. The electric generator 790 is application dependent, and as such it can be specified to be a DC electric generator or an AC electric generator that produces 50 or 60 Hertz single phase power at 220 or 110 volts, or it can be specified to produce 3 phase power. The point is it is truly an application dependent entity. Depending on the application the electric generator 790 can be connected to the grid directly or via an intermediate device called an inverter, or connected “behind the meter” for energy neutral or net metering applications, either directly or via an inverter.

### Below Stationary Platform 460

The main bearing vertical shaft assembly 700, protrudes below stationary platform 460 as does the vertical I/O shaft 471 which is also stepwise tapered and includes a tapered spline segment just prior to each to each step.

To provide a stationary reference for the upper half of ratchet 552 the bottom portion 776 of the main bearing vertical shaft assembly 700 is machined with a threaded segment that has a precision concentric relationship to the center of the vertical I/O shaft 471. During assembly the ratchet 551 & 552 is slipped over the vertical I/O shaft from the underside on to its non-tapered spline segment (provides vertical positioning tolerance) and screwed onto the bottom portion 776 of the main bearing vertical shaft assembly 700, via the threaded segment within hub 562 that is hard coupled to the top half of ratchet 552 and thus provides a solid, non-rotating home for ratchet assembly 551 & 552 which allows the sun gear 439 that is coupled to the lower half of ratchet 551 by hub 543 to either free wheel around stationary hub 562 or to be held stationary to it when the sun gear 439 tries to reverse direction.

The bottom portion of the vertical I/O shaft 471 mates with the hub 513 of the rotor 411 via its tapered spline segment. The splined end or segment of the vertical I/O shaft positions the rotor 411 over a reservoir 450 of fluid such that the fluid distributor 421 that is hard coupled to the rotor 411 by support(s) 413 is positioned to be partially submerged in the reservoir 450. The rotor 411 is held and locked on to the vertical I/O shaft by slipping a tapered spline plug (not shown) that snugly mates with the bottom portion of hub 513, over a threaded tip (not shown) of the vertical I/O shaft 471 that protrudes through hub 513, then using a lug-nut type device and tightening it, the tapered spline plug compresses the rotor hub 513 between two tapered splines on to the vertical I/O shaft 471, while simultaneously mating splined hub 543 to ratchet 551.

### DETAILED DESCRIPTION . . . FROM A PRODUCIBILITY AND MAINTAINABILITY VIEWPOINT

The horizontally oriented turbine runner 431 referenced in FIG. 7 was configured to have the identical performance to that of the vertically oriented turbine runner 431 in FIG. 4. It was also decided that the following exploded view discussion should focus on transitioning the rudimentary functional mechanical concepts used to define the initial vertical turbine embodiment of FIGS. 5 and 6 to a more producible and maintainability design with a goal of maximizing commonality between vertical and horizontal turbine configurations. To that end many of the individual piece parts depicted in the vertical turbine embodiment of FIG. 5 have been grouped into sub-assemblies in FIG. 7, that have minimal interfaces to other individual parts and sub-assemblies, including a main bearing vertical shaft assembly that includes a vertical I/O shaft 471 that is step-tapered and machined with five high torque non-slip tapered spline segments, three above stationary platform 460 to mate with rpm sensor 590, break disc 591 and generator coupling 795, and two below to mate with ratchet assembly 551 and 552, and to hub 513 for quick connect/and disconnect of rotor 511 that offers precision alignment and blind mating.

The following sections describe the functionality of each major sub-assembly and mechanical interconnect. What is described below equally applies to the embodiments of the vertical turbine in FIGS. 5 and 6.

### Main Bearing Vertical Shaft Assembly

In FIG. 5, the functional requirement for a means to support the rotor 411 assembly was recognized via the individual piece-parts with the identification of a vertical I/O shaft 471, an integral shaft collar 573, thrust bearing 575 and main bearing 479 for axial rigidity. It was shown in the context of function requirements. In FIG. 7, a main bearing vertical shaft assembly 700 is identified, which integrates the above said functional group of parts into one testable assembly 700 and expands its functionality to act as a support structure for the ratchet assembly 551 and 552 function below it. By incorporating on the bottom portion 776 of the main bearing that protrudes below the stationary platform 460 machined threaded segment that is used by the top half of the ratchet assembly 551 & 552 via a mating threaded hub 562 as an anchoring facility and snug connection to a stationary reference that is aligned with vertical I/O shaft 471.

### Ratchet Assembly

The ratchet assembly 551 & 552, also known in literature as a ratcheting freewheel mechanism (Van Anden 1869) or freewheeling ratchet assembly that is used in the rear hubs of bicycles to allow the rear wheel to rotate faster than power train (peddles) which is analogous to the function require here. During initialization, the ratchet 551 must freewheel. In the power generation mode when the fluid dynamic power exceeds the external power, the ratchet assembly 551 & 552 engages and prevents the sun gear 539 from rotating.

The upper half of ratchet assembly 551 & 552 preferably includes an integral hub 562 where the inner portion of the hub is machined to include a threaded segment that snugly fits over the threaded end of the main bearing extension 776, providing the proper alignment and anchoring of the ratchet assembly 551 & 552 to the main bearing vertical shaft assembly 700, that provides a secure robust connection to a non-rotating reference, stationary platform 460.

The bottom half of the ratchet 551 preferably includes a mating splined hub, that preferably blindly engages with the sun gear hub extension 543 that acts as a shaft, having a mating machined tapered spline on its outer surface, such that when the main rotor assembly hub 513 is pushed on to the vertical shaft 471, the sun gear hub extension 543 outer splined surface also blindly engages with the mating splined hub internal to the bottom of ratchet 551.

### Rotor/Hub Assembly

The rotor hub assembly is comprised of two separate parts, the Rotor 411, and the hub 513. The rotor's main function other than manufacturing artificial gravity is to house the fluid distributor 421, the turbine runner 431 via bearing support 414, the one-to-one vertical to horizontal shaft translator gear box 732 and the positive feedback transmission consisting of drive shaft 435, bearing support 414, drive gear 437 and sun gear 439.

The hub 513 has two basic functions, it's first function is to provide the means of attaching the rotor 411, including everything it houses, to the vertical shaft 471 of the main bearing vertical shaft assembly 700, and its second function is to provide a permanent place to secure the sun gear 439 of the positive feedback transmission of the vertical and horizontal turbine embodiments when the rotor 411 is disconnected from the vertical shaft 471 via hub 513. To satisfy these requirements hub 513 is extended vertically, beyond where it would normally be, and its exterior machined and hardened to provide an accurately aligned home for the sun gear 439 of the vertical and horizontal turbine embodiments. This feature allows the entire rotor 411 to be assembled with its fluid distributor 421, turbine runner 431, and positive feedback transmission at the factory for both the vertical and horizontal turbine runner configurations and allows the entire rotor assembly to be dynamically balanced and tested before shipment.

To satisfy the normal functionality of a hub, that is to provide a means of attaching the hub 513 to the vertical shaft 471, the internal circumference of the hub 513 is preferably machined half way down the hub with a tapered spline to match that of vertical I/O shaft 471 and a reverse tapered spline coming up from the bottom side of the hub 513 for using the rotor assembly in applications where the vertical I/O shaft 471 comes up from the bottom within/through the reservoir 450 of fluid. In either case the length of penetration of the splined segment of either vertical I/O shaft 471 into the hub is sufficient for a smaller diameter threaded segment of the vertical I/O shaft to protrude out the opposite side of the hub such that threads at that end can preferably be used with a tapered splined wedge plug and lug-nut, to compress the rotor on to the subject vertical I/O shaft, with a robust non-slip mechanical connection, that is easy to assemble and disassemble, analogous to that used on an automobile tire rim (using tapered lug-nuts), to compress the wheel snugly on the subject wheel axel. This design allows rotor assemblies to be removed and easily replaced in the field.

### Fluid Distributor Assembly

The fluid distributor 421 has two main functions, its exterior provides a low drag force when partially submerged in a fluid, and its interior function uses centrifugal force and up-hill artificial gravity siphoning to cause fluid flow from the submerged portion of the fluid distributor 421, up a mostly radial curved tube or penstock 425 to an unsubmerged point just above the reservoir surface where the fluid is expelled tangential to the rotor 411 where a nozzle is attached. The nozzle 427 is mostly tangential to the rotor, facing in a direction such that the reaction force acts to aid the initialized direction of the rotor, and aligns with the outer most buckets of the turbine runner 431 and at the turbines specified angle of attack 629.

Because there are both vertical conduits 713 or tubes and mostly horizontal radial curved conduits or tubes (penstocks 425) involved, the fluid distributor may be constructed in two pieces. The vertical or barrel of the funnel and the vertical conduits 713 inside can be viewed as a cylindrical bar where the conduits are drilled out, but in practice will be fabricated from an injection mold process. The radial upper portion entity is viewed as an injection molded entity also. From an economic view point if nothing else, this entity will probably be a two-piece assembly with seams along the midpoint contour of the mostly radial curved conduits or penstocks 425. Our baseline is to mold-in cylindrical radial curved penstock(s) 425, but will also consider rectangular radial curved penstock(s) 425 to possibly further minimize the Coriolis and fluid momentum effects. In final assembly the two half's of the radial portion are glued together then the hollowed out cylinder or barrel entity will be aligned with the mating radial entity and cemented together to form a one piece fluid distributor 421.

### Turbine & Turbine Bearing & Vertical Shaft Assembly

The turbine bearing & vertical shaft assembly 716, is an entity that can be manufactured in a competitive production environment and installed onto the rotor 411 of the fluid dynamic energy generator/motor. The bottom part of its shaft 733 is preferably specified to be the standard slip-on tapered spline with a threaded segment below to mate with a custom mating splined arbor (fancy name for hub) of the turbine runner 431 that can be compressed on to the turbine bearing & vertical shaft assembly 716. The upper portion of its shaft 733 is also specified to be compatible with the standard tapered spline slip-on fit specified above, for connecting the vertical to horizontal shaft translator gear box 732.

### Positive Feedback Transmission

The positive feedback transmission is preferably comprised of drive shaft 435 and drive gear 437, but from an assembly and maintenance view point, bearing support 414 preferably becomes an integral part of that subassembly, and is typically the last subassembly to be installed on the rotor 411. The turbine shaft 435 of the subassembly preferably uses the standard tapered spline to connect the said shaft to the vertical to horizontal shaft gear box 732.

During assembly the shaft 435 is mated with gear box 732, and the drive gear 437 is mated to the proper tooth of the sun gear 439, and the bearing support 414 is then preferably hard coupled to a recessed indenture on the rotor 411 providing horizontal and vertical alignment and sheer strength support to turbine runner shaft 435.

### Reservoir

The baseline reservoir fluid is typically pH balanced water with an anti-freeze additive. Other fluids including vegetable and corn oil, petroleum based oils, and eventually new blends of fluid tailored to this application including nano-technology coatings that are available today on interior and exterior surfaces of the fluid distributor to improve flow and reduce drag, are but a few of the possible alternatives.

Furthermore, the reservoir is preferably just not fluid, it preferably contains stationary internal structures to: (i) reduce fluid drag on the submerged portion of the funnel-shaped fluid distributor of the rotor assembly; and (ii) guide the large volume of energy depleted fluid (296 to 451 gals per minute from three to six fluid dynamic channels for the prototype and first production units) from the 360 degree circumference of the reservoir where the energy depleted fluid is deposited by the turbine runners 431, and optimally must be sent back down to the bottom-center of the reservoir to be recirculated up through the vertical intake tube 713 into penstock 425.

As the funnel shaped fluid distributor 421 is rotated, surface tension causes the entire reservoir fluid to spin and thus to climb the sidewalls of the reservoir containment system. To minimize this, and its small but associated drag force on the rotor 411 assembly, the reservoir may house a stationary non-rotating funnel shaped structure 777, into which the funnel shaped fluid distributor 421 is positioned over forming a fluid bearing between the two funnel shapes that dramatically reduces the fluid drag, and also minimizes the reservoir fluid from spinning and climbing the reservoir 450 containment walls.

Also, the reservoir containment structure may house a “J” shaped extrusion (not shown) that forms a narrow 360 degree plenum with the reservoir 450 walls and bottom of the reservoir 450. At or near the bottom center of the reservoir 450 the bottom portion of the “J” shaped plenum forces the 360 degree downward return flow to be directed upward toward the input port of the partially submerged fluid distributor and into vertical penstock(s) 713 and its connected mostly horizontal penstock(s) 425 where the fluid is reaccelerated and forced out nozzle(s) 427, then captured by turbine runner(s) 431, etc., etc., and the energy depleted fluid is returned to the reservoir near its' circumference as a mostly downward 360 degree fountain of fluid into the 360 degree “J” shaped plenum in an endless fashion

### Frame and Containment Housing

The preferred embodiment of the prototype does not include a housing, but rather it consists of a stationary platform 460 or stage that houses the entire artificial gravity fueled energy generator/motor. The stage may have alignment/centering cams protruding from the bottom of the stage, but accessible from the top, to allow blind positioning of the stage on the reservoir containment rim, and then to provide sufficient horizontal alignment accuracy to fit the funnel shaped fluid distributor symmetrically into the stationary drag reducing funnel structure 777.

It may be necessary to pressurize the inside cavity of the housing where the rotor assembly resides to prevent cavitation of the fluid due to external exposure to high temperatures and/or the purposeful creation of low pressure suction heads within the penstocks of the fluid distributor. In the preferred prototype embodiment, if pressurization of the reservoir fluid is to be evaluated, the entire system will preferably be placed in a pressurized chamber, the unit will be characterized and before production appropriate seals will be added to the bottom of stationary platform 460 interface to the reservoir containment rim and to the main bearing vertical shaft assembly 700.

Also, the frame or containment structure should also preferably include a safety protection collar that can capture and restrain parts and sub-assemblies that might fly off the rotor 411 due to catastrophic failures.

FIG. 8 depicts the top view of 3 or 6 channel horizontal turbine rotor assembly including positive feedback transmission. This figure is very similar to FIG. 6, the key differences in the fluid dynamic, and positive feedback functional areas are:
From the fluid dynamic stand point, the key difference is the turbine runners 431 have been flipped to a horizontal orientation. The fluid distributor that houses penstock(s) 425 is identical to vertical turbine fluid distributor. The nozzles 427 that were directed tangential and in the same plane as the rotor in the vertical turbine case in FIG. 5 are now still directed tangential, but are now pointed slightly upward by an amount equal to the angle of attack 629 specified by the turbine runner manufacturer, such that the fluid velocity (Vj) jetting from nozzle 427 strikes the turbine runner 431 buckets at their optimum angle for maximum fluid power transfer.
From a positive feedback transmission view point, the key difference as seen from this top view of FIG. 8 is the drive shaft 435 is now supported by one bearing support 414 and gear box 732 that replaced the functionality of bearing support 412 of FIG. 6.
Gear box 732 transforms turbine runner vertical shaft 733 rotation to drive shaft 435 rotation with a one to one gear ratio, where the direction of rotation is identical to that of drive shaft 435 in FIG. 6.

In operation, initially external cranking energy or power rotates vertical I/O shaft 471 in the clockwise (CW) direction. Since it is hard coupled to hub 513 and hub 513 is hard coupled to rotor 411, all three rotate in lock step as does sun gear 439 due to its connection to ratchet, via hub-like shaft 543, that allows CW rotation of the sun gear, and its meshed connection with drive gear 437 that is not yet spinning but is being dragged around the vertical I/O shaft 471 by the drive gears connection to drive shaft 435. This shaft is connected to bearing support 414 and vertical to horizontal gear box 732 that are both hard coupled to rotor 411 that is rotating in lock step with the vertical I/O shaft.

As the vertical I/O shaft and its hard connected hub 513 is rotated faster and faster fluid begins to flow and spins the turbine runner 431, drive shaft 435 and drive gear 437 in a direction to slow the sun gear 439 rpm down relative to the rotor hub 513 to the point that the sun gear 439 tries to go from CW rotation through zero rotation and thus reverse it's apparent direction of rotation as observed by the ratchet assembly by its connection to sun gear 439 via hub-like shaft 543 at which point this condition is detected by the ratchet assembly and the sun gear 439 is locked to a nonrotating stationary member and the drive gear 437 begins to use the sun gear 439 as a roadway.

At this point the real power generation process begins. The bottom line effect of this is the rotor 411 begins to rotate at a slightly faster rotational rate or rpm than the external energy source 481 is rotating it, thereby incrementally incrementing artificial gravity, which increases the released kinetic energy emanating from nozzle 427, which increases the velocity, Vj, of fluid emanating from nozzle 427, which increases the vertical turbine runner 431 circumferential velocity and the drive gear 437 speed causing the rotor 411 speed to incrementally increase, in a recursive cycle, eventually attaining a rotational speed or rpm that completely replaces the external energy source that it took to get the rotor 411 to this energy producing state.

To minimize the Coriolis force that acts contrary to the cranking energy, the penstocks 425 are curved in a partial spiral contour from point of entry near the center of rotation toward the circumference, where the fluid exits tangential to the rotor 411, but displaced 1 radian (approximately 60 degrees) for a penstock cross sectional area to nozzle cross sectional area ratio of 1 to 1, 120 degrees for a 1 to 2 area ratio, 180 degrees for a 1 to 3 area ratio, in a curved partial spiral contour that the fluid would have traversed had it not been contained in a penstock

FIGS. 9A and 9B depict a typical behind the meter grid connected application of the artificial gravity fueled fluid dynamic energy generator/motor 799 connected to electric generator 790 via coupling 795. Initially the electric generator's electrical input/output connection 796 will be through a modified commercially available bidirectional inverter 900 with outputs to household emergency circuits 960 and through a required safety switch 930 to normal household circuits 970 and on through a “net metering” meter 940 to the electrical grid 950. In this mode, entity 910 acts as a demodulator and entity 920 acts as a modulator; during the initialization mode when the grid 950 is supplying electrical power to the generator that is acting as a motor, entity 920 acts as a demodulator and entity 910 acts as a modulator. In later generations, after several years of regulatory specification and testing, the inverter will be eliminated and the generator 790 electrical input/output connection 796 will be connected directly to switch 930 and emergency circuits 960, and the other end of the switch 930 will remain connected as shown to a “net metering” meter 940 and on to the grid 950. The switch will always be required to prevent generator 790 from providing power to the grid when the grid is down or being repaired to prevent inadvertent electrocution of workers.

During start up, or after a maintenance action the bidirectional inverter supplies grid power to the electric generator 790 turning it into an electric motor which drives the artificial gravity fueled energy generator/motor 799 via shaft coupling 795 until the artificial gravity fueled energy generator/motor 799 rpm exceeds that of the grid powered electric motor 790 rpm by a tiny amount signifying to the electric motor 790 that it is now acting as a generator and thus the artificial gravity fueled energy generator/motor 799 takes control of spinning coupling 795, truly converting the electric motor back into an electric generator 790.

During electric grid power failure, the switch 930 in the inverter 900 opens and disconnects from the normal household circuits 970 and the “net metering” meter 940 stopping all generated power from reaching the grid 950, but stays connected to the emergency household circuits 960 and thus provides emergency power to critical circuits, and at the very minimum supplies emergency/back-up power to the home for the duration of the power failure, without batteries or energy storage devices. For a properly scaled unit the monthly energy bill (using today's sell-back rates) will be zero.

Unless defined otherwise, all technical terms used herein have the same meaning as commonly understood by one of ordinary skill in the art to which this invention belongs. Any methods and materials similar or equivalent to those described herein also can be used in the practice or testing of the present disclosure

It must be noted that as used herein and in the appended claims, the singular forms “a”, “and”, and “the” include plural references unless the context clearly dictates otherwise.

While the present disclosure has been described with reference to the specific embodiments and examples thereof, it should be understood by those skilled in the art that various changes may be made and equivalents may be substituted without departing from the true spirit and scope of the invention. In addition, many modifications may be made to adopt a particular situation, material, composition of matter, process, process step or steps, to the objective spirit and scope of the present disclosure. All such modifications are intended to be within the scope of the claims appended hereto.

1. A method of generating artificial gravity fueled fluid power, capturing it, and sustaining it, comprising the steps of:
using an external energy to rotate a vertical I/O shaft, an attached rotor, and a fluid distributor attached to said rotor wherein said rotor is partially submerged in a reservoir of fluid, and said fluid distributor houses at least one penstock partially submerged in said reservoir of fluid;
manufacturing exponential amounts of artificial gravity for linear changes in rotor rpm,
coupling said artificial gravity to the fluid in the at least one penstock;
generating a rotary domain energy or available power from a stream of fluid that jets out from at least one nozzle from said at least one penstock;
pointing said at least one nozzle tangentially to said rotor to capture a reaction force and to assist in the rotation of said rotor;
capturing a mass flow rate jetting from said at least one nozzle;
transforming a fluid dynamic power into a rotational mechanical power;
connecting the captured rotational mechanical power from at least one turbine runner to at least one drive shaft;
spinning at least one drive gear that is meshed to a sun gear;
locking said sun gear to a stationary reference when said sun gear tries to reverse its direction of rotation;
rotating said drive gear pulling an entire rotor assembly around the sun gear;
extracting rotational energy or power from the rotating rotor mass and coupling it to the vertical I/O shaft to which it is coupled;
repeat the process steps above beginning with manufacturing exponential amounts of artificial gravity.

2. A generator/motor comprising:
a braking system controller;
a main bearing vertical shaft assembly connected to said braking system controller;
a stationary platform connected to said main bearing vertical shaft assembly;
a ratchet assembly connected to said main bearing vertical shaft assembly;
a rotor connected to said main bearing vertical shaft assembly via hub 513 and wherein said rotor supports a fluid distributor;
a turbine runner connected to said turbine shaft wherein said turbine shaft is connected to gear box via bearing;
a drive shaft connected to said gear box supported by bearing support a drive gear connected to said turbine shaft;
a sun gear coupled on hub via bearing where said sun gear meshes with drive gear;
a sun gear hub extension connected to said sun gear wherein said hub extension mates with ratchet when the vertical I/O shaft of the main bearing vertical is mated to hub;
wherein the said fluid distributor includes at least one penstock including an associated nozzle configured to propel a fluid from a reservoir to said turbine runner.

3. The generator/motor of claim 2, wherein the main bearing vertical shaft assembly includes:
a mounting flange attached to said main bearing vertical shaft assembly that provides a single mounting surface for mounting the main bearing vertical shaft assembly to the chassis of generator/motor equipment without modification.

4. The generator/motor of claim 2, wherein the main bearing vertical shaft assembly includes:
an internal collar on the vertical shaft, and a thrust bearing within the main bearing vertical shaft assembly, and at least one axial bearing within the bearing assembly.

5. The generator/motor of claim 2, wherein the main bearing vertical shaft assembly includes a main bearing housing that protrudes below the mounting surface of said mounting flange, by a sufficient amount to protrude through the stationary mounting stationary platform to act as a precision splined support and alignment structure that is concentric to the main bearing vertical shaft for aligning the upper half of the ratchet assembly both vertically and axially to the vertical I/O shaft of said main bearing vertical shaft assembly.

6. The generator/motor of claim 2, wherein the upper half of the ratchet assembly includes an integral donut shaped tapered splined hub, that provides a precision robust power handling mechanical connection, to the stationary platform via the main bearing tapered splined that protrudes below the stationary mounting stationary platform

7. The generator/motor of claim 2, wherein a bottom half of the ratchet assembly includes a hub-like recessed tapered spline internal to the bottom half of the ratchet, that engages with the sun gear hub extension that acts as a tapered spline shaft, such that when the external rotor assembly is pushed on to the main bearing vertical shaft, the sun gear hub extension engages with the bottom half of the ratchet assembly.

8. The generator/motor of claim 2, wherein the rotor is hard-coupled to a hub that attaches said rotor to said main bearing vertical shaft assembly.

9. The generator/motor of claim 8, wherein said hub is extended vertically to secure the sun gear, when the rotor assembly, is disconnected from the vertical shaft of the main bearing vertical shaft assembly, and also to keep the sun gear fully meshed with the drive gear even when the rotor is disconnected from a vertical shaft.

10. The generator/motor of claim 9, wherein said hub provides an alternate bottom mount for supporting said rotor wherein the hub includes an inverse spline taper in the bottom of the hub; where said vertical shaft is protected and housed in a structural hollow column-like casing and where both configurations use a tapered spline plug that slips over a smaller diameter threaded end of the shaft where a lug-nut compresses the tapered spline interfaces to the hub snuggly on to the vertical shaft of the main bearing vertical shaft assembly.

11. The generator/motor of claim 2, wherein said funnel-shaped fluid distributor is comprised of two separate molded entities the vertical barrel that contains vertical penstocks, and the radial upper portion that contain the radial curved penstocks, where the two pieces aligned and fastened (glued) together to form the shallow funnel-shaped exterior angle of about 12.5 degrees that the penstock traverses from where they enter the fluid distributor at rl near the center of rotation to where they exit the rotor tangential to its circumference.

12. The generator/motor of claim 2, wherein said turbine is a horizontal turbine.

13. The generator/motor of claim 2, wherein said turbine is a vertical turbine.

14. The generator/motor of claim 2,
said sun gear is free to spin in the clockwise direction in unison with the rotor while there is no fluid power being generated, sun gear rotates in unison with the rotor, and ratchet free-wheels;
as the rotor is accelerated faster with external cranking energy, fluid power spins the turbine runners and connected drive gears thus slowing the sun gear down ;
as the rotor is accelerated further with external cranking energy fluid power spins the turbine runners and connected drive gears to the point where the sun gear tries to reverse its direction of rotation, the ratchet stops free-wheeling and locks to a stationary platform reference, inhibiting the sun gear from turning.

15. The generator/motor of claim 2, wherein the rotor assembly uses the sun gear in concert with a now locked ratchet and now stationary sun gear that connect the drive gear to rotate around, rotating with it the entire rotor assembly including the vertical I/O shaft of the main bearing vertical shaft assembly to which it is coupled to via the rotors' hub;
initially contributing to the external cranking power, forcing the rotor to rotate faster, manufacturing more artificial gravity, more fluid dynamic power in the form of mass flow rate and velocity, resulting in faster turbine and drive gear speeds and ultimately faster rotor and vertical shaft speeds;
the above said process continues until the generated fluid dynamic power exceeds the external supplied cranking power and totally replaces it;
in the limit the said process would continue endlessly, producing more and more fluid dynamic power, and more and more rotational mechanical power on the vertical shaft of the main bearing vertical shaft assembly if the said vertical shaft were not loaded with reflected braking power of an electrical loaded electric generator, and/or a disc brake control entity.

16. The generator/motor of claim 2, wherein said fluid in said reservoir is one of pH balanced water, glycol base radiator fluid, vegetable oil, corn oil, and petroleum based oils, and fluids.

17. The generator/motor of claim 2, wherein said reservoir includes stationary internal structures to reduce fluid frictional drag on the fluid distributor and to guide the energy depleted fluid from the turbines back down to the bottom center of the reservoir with minimal turbulence.

18. The generator/motor of claim 2, wherein the fixed 1:1 coupling between the vertical I/O shaft and the shaft of the electric generator can be replaced with a simple elliptic gear train to provide a constant 3600 rpm output to the electric generator at the chosen operating frequencies of 600 and 900 rpm by choosing the sun and planet gearing to have a 6:1 or a 4:1 increase in rpm by connecting the ring gear to a stationary member of the invention, the vertical I/O shaft to the planet carrier that houses three planet gears, and the sun gear to the electric generator shaft.

19. The generator/motor of claim 2, wherein said stationary platform includes alignment/centering cams protruding from the bottom of the stationary platform, but accessible from the top, to allow blind positioning the stationary platform on the rim of said reservoir containment structure to provide sufficient horizontal and vertical alignment accuracy to position the fluid distributor symmetrically into the stationary drag reducing funnel structure housed in the reservoir.
